(19) United States
(12) Patent Application Publication
(10) Pub. No.: US 2025/0133171 A1
(43) Pub. Date: Apr. 24, 2025

(54) RECORDING APPARATUS AND RECORDING SYSTEM

(71) Applicant: BROTHER KOGYO KABUSHIKI KAISHA, Nagoya (JP)

(72) Inventor: Tetsuya OKUNO, Nagoya (JP)

(73) Assignee: BROTHER KOGYO KABUSHIKI KAISHA, Nagoya (JP)

(21) Appl. No.: 18/906,882

(22) Filed: Oct. 4, 2024

(30) Foreign Application Priority Data
Oct. 24, 2023 (JP) 2023-182703

(51) Int. Cl. H04N 1/00

(52) U.S. Cl. CPC H04N 1/00474; H04N 1/00244; H04N 1/00413; H04N 1/0048; H04N 2201/0094

(57) ABSTRACT

A recording apparatus includes: a recording part, a display, an operating part, and a controller. The controller is configured to perform control regarding an additional function and control regarding a basic function. The controller causes the display to display a basic function selecting part via which the basic function is selected and an additional function selecting part via which the additional function is selected. In a case where a user has not given approval, the controller causes the display to display the additional function selecting part in a state that selection for executing the additional function is not ready. In a case where the user has given the approval, the controller causes the display to display the additional function selecting part in a state that the selection for executing the additional function is ready.

### REFERENCE TO RELATED APPLICATIONS

This application claims priority from Japanese Patent Application No. 2023-182703 filed on Oct. 24, 2023. The entire content of the priority application is incorporated herein by reference.

### BACKGROUND ART

As an example of a recording apparatus, a multifunction peripheral having a plurality of different functions such as a copy function, a scanner function, a print function, a facsimile function, etc., is publicly known. A certain publicly known multifunction peripheral is configured so that a new application which is not originally included in the multifunction peripheral can be added and used, in a case where a user operates an operation button so as to connect the multifunction peripheral to the Web.

### SUMMARY

As in the above-described multifunction peripheral as the recording apparatus, in a recording apparatus to which the additional function can be added, the recording apparatus becomes capable of executing the additional function in a case where the user gives approval. However, in such a configuration, the user might have difficulty to understand what kind of additional function is to be added before giving the approval and thereby adding the additional function, in some cases.

An object of the present disclosure is to provide a recording apparatus and a recording system including the recording apparatus each of which allows the user to easily understand what kind of additional function is to be added before the user approves the addition of the additional function.

A recording apparatus of the present disclosure includes: a recording part; a display; an operating part operable by a user; and a controller. The controller is configured to perform control regarding an additional function which is executed by the recording apparatus after the recording apparatus and an external apparatus are connected and after approval is given by the user, and control regarding a basic function which is executed by the recording apparatus before the recording apparatus and the external apparatus are connected. The controller is configured to execute: (i) causing the display to display a basic function selecting part which is selected by an operation of the operating part and via which the basic function is selected and an additional function selecting part which is selected by the operation of the operating part and via which the additional function is selected; (ii) in a case where the user has not given the approval, causing the display to display the additional function selecting part in a state that selection for executing the additional function is not ready; and (iii) in a case where the user has given the approval, causing the display to display the additional function selecting part in a state that the selection for executing the additional function is ready.

A recording system of the present disclosure includes: a recording apparatus including a recording part; an external apparatus including a controller and being configured to communicate with the recording apparatus; a display configured to communicate with at least one of the recording apparatus and the external apparatus; and an operating part configured to allow a user to operate. The recording apparatus is configured so that an additional function can be added to the recording apparatus by an approval given by a user, the additional function being different from a basic function which is executed before the recording apparatus and the external apparatus are connected. The controller is configured to execute, by controlling the recording apparatus or the display: (i) causing the display to display a basic function selecting part which is selected by an operation of the operating part and via which the basic function is selected and an additional function selecting part which is selected by the operation of the operating part and via which the additional function is selected, (ii) in a state that the user has not given the approval, causing the display to display the additional function selecting part in a state that selection for executing the additional function is not ready, and (iii) in a state that the user has given the approval, causing the display to display the additional function selecting part in a state that the selection for executing the additional function is ready.

In the present disclosure, in the state that the user has not yet given the approval, the controller causes the display to display the additional function selecting part in the state that the selection for executing the additional function is not ready. Further, in the state that the user has given the approval, the controller causes the display to display the additional function selecting part in the state that the selection for executing the additional function is ready. With this, the user can easily understand what kind of additional function is added before approving the addition of the additional function. Further, the user can add the additional function after being convinced of the ease of use of the additional function. Furthermore, such a situation is less likely to occur that although the user has added the additional function, the user is not satisfied with the ease of use of the additional function, and thus the user does not use the additional function after all.

Moreover, the user can easily understand what kind of additional functions will be added before giving the approval. In other words, since the additional function is displayed in the recording apparatus in a non-selectable state that the additional function cannot be selected, the user has more opportunities to learn about the additional function and to decide whether the additional function is necessary for the user himself or herself. Owing to this, such a probability that the user might miss an opportunity to use the additional function since the user is not aware of the presence of the additional function is reduced, thereby improving the productivity of the user.

### BRIEF DESCRIPTION OF DRAWINGS

FIG. 1 is a diagram depicting the schematic configuration of a recording apparatus.

FIG. 2 is a diagram depicting the schematic configuration of a recording part.

FIG. 3 is a diagram depicting the schematic configuration of a reading part.

FIG. 4A is a diagram of FIG. 3 as seen from the direction of arrow IV, and FIG. 4B is a diagram depicting a state that a cover of FIG. 4A is open.

FIG. 5 is a block diagram depicting the electrical configuration of a recording system including the recording apparatus.

FIG. 6A is a diagram for illustrating a main screen in a state that the recording apparatus is not connected to a network, FIG. 6B is a diagram for illustrating the main screen in a case where although the recording apparatus is connected to the network, the recording apparatus is in a state that the recording apparatus is not ready for communicating with a server, FIG. 6C is a diagram for illustrating the main screen in a state that the recording apparatus is connected to the network and is ready for communicating with the server and an account registration has not been made, and FIG. 6D is a diagram for illustrating the main screen in a state that the recording apparatus is connected to the network and is ready for communicating with the server and that the account registration has been made.

FIG. 7A is a diagram for illustrating an unregistered account screen, FIG. 7B is a diagram for illustrating an input screen for account registration, and FIG. 7C is a diagram for illustrating a registration content confirming screen.

FIG. 8 is a diagram for illustrating an application selecting screen.

FIG. 9A is a diagram for illustrating an image data selecting screen in a function by a first application, FIG. 9B is a diagram for illustrating a recording setting screen in the function by the first application, FIG. 9C is a diagram for illustrating a completion screen in the function by the first application, and FIG. 9D is a diagram for illustrating an input screen in the function by the first application.

FIG. 10 is a sequence diagram depicting the flow of a process in a controller of the recording apparatus, a controller of a server, and an external terminal in a case where an image corresponding to image data stored in the external terminal is to be recorded in the recording apparatus by the function of the first application.

FIG. 11A is a diagram for illustrating an input screen in a function by a second application, FIG. 11B is a diagram for illustrating a data format selecting screen in the function by the second application, and FIG. 11C is a diagram for illustrating a resolution setting screen in the function by the second application.

FIG. 12 is a sequence diagram indicating the flow of a process in the controller of the recording apparatus and the controller of the server in a case where image data of an image read in the reading part is attached to an e-mail and sent or transmitted by the function of the second application.

FIG. 13A is a diagram for illustrating a data format selecting screen in a function by a third application, FIG. 13B is a diagram for illustrating a retention period setting screen in the function by the third application, FIG. 13C is a diagram for illustrating a completion screen in the function by the third application, and FIG. 13D is a diagram for illustrating an input screen in the function by the third application.

FIG. 14 is a sequence diagram indicating the flow of a process in the controller of the recording apparatus, the controller of the server, and the external terminal in a case where image data of an image read in the reading part is to be stored in the external terminal by the function of the third application.

FIG. 15A is a diagram for illustrating a recording setting screen, FIG. 15B is a diagram for illustrating an image data selecting screen in a case where the recording apparatus is not ready for communicating with the server, FIG. 15C is a diagram for illustrating the image data selecting screen in a case where the recording apparatus is ready for communicating with the server and where the account registration has not been made, and FIG. 15D is a diagram for illustrating the image data selecting screen in a case where the recording apparatus is ready for communicating with the server and where the account registration has been made.

FIG. 16A is a flowchart depicting the flow of a process of the controller of the recording apparatus in a case where an image corresponding to image data of a first data format is to be recorded, and FIG. 16B is a sequence diagram depicting the flow of a process of the controller of the recording apparatus and the controller of the server in a case where an image corresponding to image data of a second data format is to be recorded.

FIG. 17A is a diagram for illustrating a recording setting screen in an example wherein a recording of a high image quality cannot be selected in the function of the first application in a case where the account registration has not been made; FIG. 17B is a diagram for illustrating the recording setting screen in an example wherein a part of data formats cannot be selected in the function of the second application in the case where the account registration has not been made; FIG. 17C is a diagram for illustrating the recording setting screen in an example wherein a part of the resolutions cannot be selected in the function of the second application in the case where the account registration has not been made; and FIG. 17D is a diagram for illustrating the recording setting screen in an example wherein a part of retention periods cannot be selected in the recording by the function of the third application in the case where the account registration has not been made.

FIG. 18 is a diagram for illustrating the main screen which is caused by the controller not to display the additional function selecting part in the state that the recording apparatus is not ready for communicating with the server.

### DESCRIPTION

In the following, an embodiment of the present disclosure will be described.

### Overall Configuration of Recording Apparatus

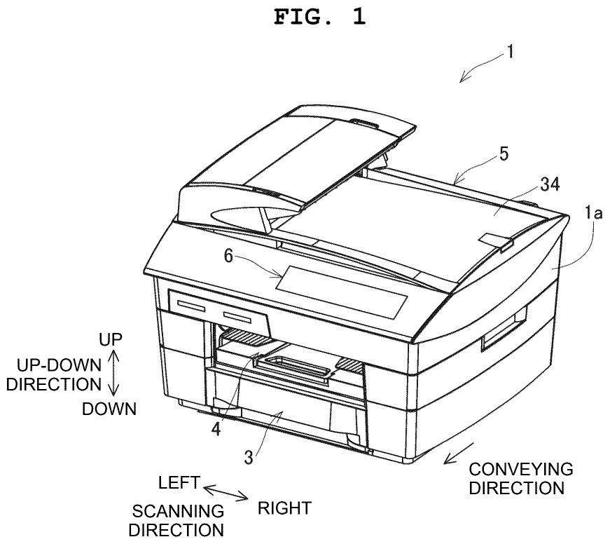

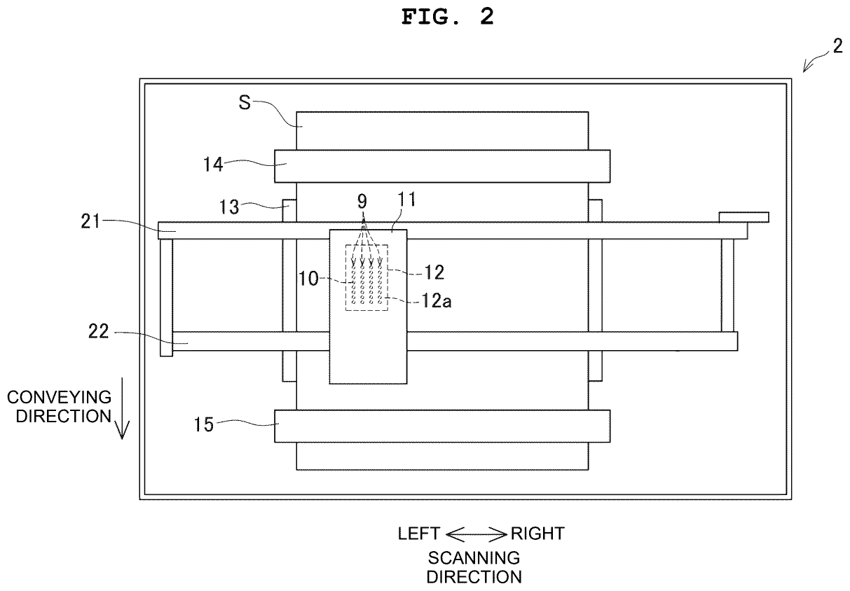

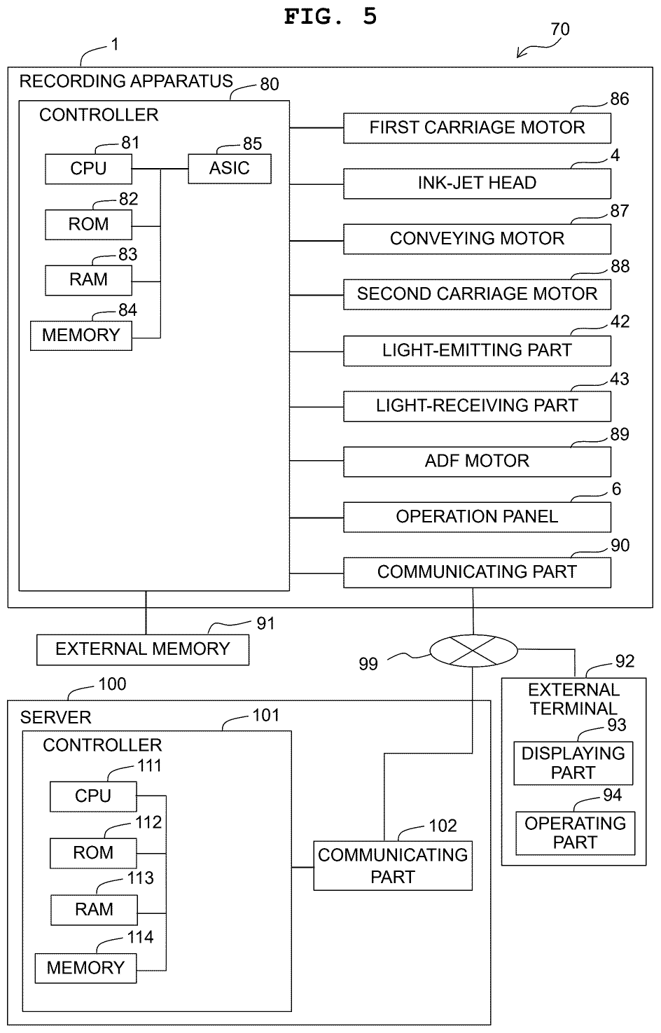

A recording apparatus 1 of the present embodiment is a so-called multifunction peripheral capable of recording on a sheet S as well as reading an original, etc. As depicted in FIG. 1, the recording apparatus 1 according to the present embodiment includes a recording part 2 which is depicted in FIG. 2, a conveyor 3, a discharging part 4, a reading part 5, an operation panel 6, and a controller 80 (see FIG. 5).

The recording part 2 is disposed inside the recording apparatus 1, and is a part which performs a recording of an image on the sheet S. The recording part 2 will be described in detail later. The conveyor 3 feeds the sheet S to the recording part 2. The discharging part 4 is a part to which the sheet S, having the recording performed thereon by the recording part 2, is discharged. The reading part 5 is a part which performs a reading of the image. The reading part 5 will be described in detail later.

The operation panel 6 is, for example, a touch panel. As will be described later, various selecting parts, each of which is selected by a user, are displayed on the operation panel 6; in a case where the user touches a part, of the operation panel, which displays each of the respective selecting parts, the user is capable of selecting the touched selecting part. Note that the operation panel 6 of the present embodiment is an example of an integrated member of a “display” and an “operating part” of the present disclosure. Further, instead of the operation panel 6, a display such as a liquid crystal display and an operating part such as a button may be separately included in the recording apparatus 1. In this case, a selecting part which is displayed in the display, based on an operation of the operating part by the user, is selected.

### Recording Part

Next, the recording part 2 will be described in detail. As depicted in FIG. 2, the recording part 2 includes a first carriage 11, an ink-jet head 12, a platen 13, and conveying rollers 14 and 15.

The first carriage 11 is supported by two guide rails 21 and 22 which extend in a horizontal scanning direction. Note that in the following, the right side and the left side of the scanning direction are defined as depicted in FIGS. 1 and 2. The first carriage 11 is connected to a first carriage motor 86 depicted in FIG. 5 via a non-illustrated belt, etc. In a case where the first carriage motor 86 is driven, the first carriage 11 moves along the guide rails 21 and 22 in the scanning direction.

The ink-jet head 12 is mounted on the first carriage 11. The ink-jet head 12 ejects an ink from a plurality of nozzles 10 formed in a nozzle surface 23a which is the lower surface of the ink-jet head 12. To provide a more detailed description, the plurality of nozzles 10 construct four nozzle rows 9 which are disposed side by side in the scanning direction in the nozzle surface 12a. Each of the nozzle rows 9 is aligned in a conveying direction which is horizontal and orthogonal to the scanning direction. Black, yellow, cyan, and magenta inks are ejected from the plurality of nozzles 10, in an order from a nozzle row 9 which is included in the four nozzle rows 9 and which is located on the rightmost side in the scanning direction.

The platen 13 is disposed below the ink-jet head 12 and faces the plurality of nozzles 10. The platen 13 extends over the entire length of the sheet S in the scanning direction and supports the sheet S from below. The conveying roller 14 is disposed on the upstream side of the ink-jet head 12 and the platen 13 in the conveying direction. The conveying roller 15 is disposed on the downstream side of the ink-jet head 12 and the platen 13 in the conveying direction. The conveying rollers 14 and 15 are connected to a conveying motor 87 depicted in FIG. 5 via a non-illustrated gear, etc. In a case where the controller 80 drives the conveying motor 87, the conveying rollers 14 and 15 rotate and the sheet S is thereby conveyed in the conveying direction.

Further, the recording part 2 is configured to repeatedly perform a recording pass and a conveying operation to thereby record an image on the sheet fed from the conveyor 3. In the recording pass, the controller 80 causes the ink-jet head 12 to eject the ink(s) from the plurality of nozzles 10 toward the sheet S while the controller 80 drives the first carriage motor 86 so as to move the first carriage 11 in the scanning direction. In the conveying operation, the controller 80 drives the conveying motor 87 so as to cause the conveying rollers 14 and 15 to convey the sheet S in the conveying direction. The sheet S on which the image has been recorded is discharged to the discharging part 4.

### Reading Part

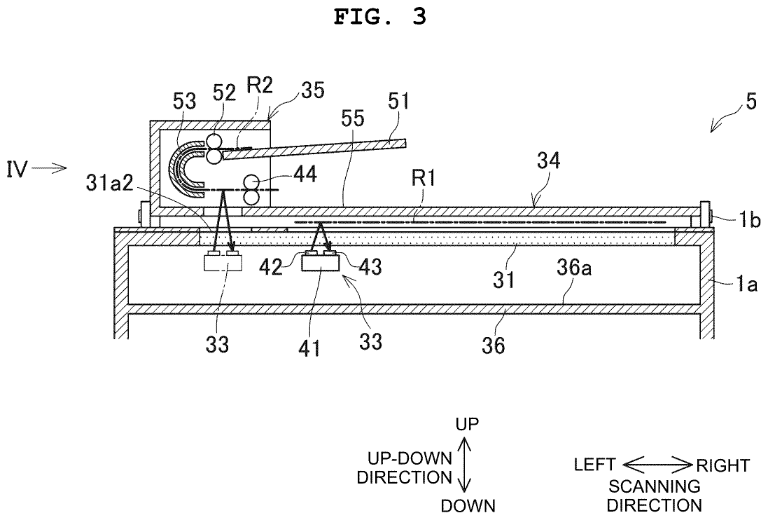

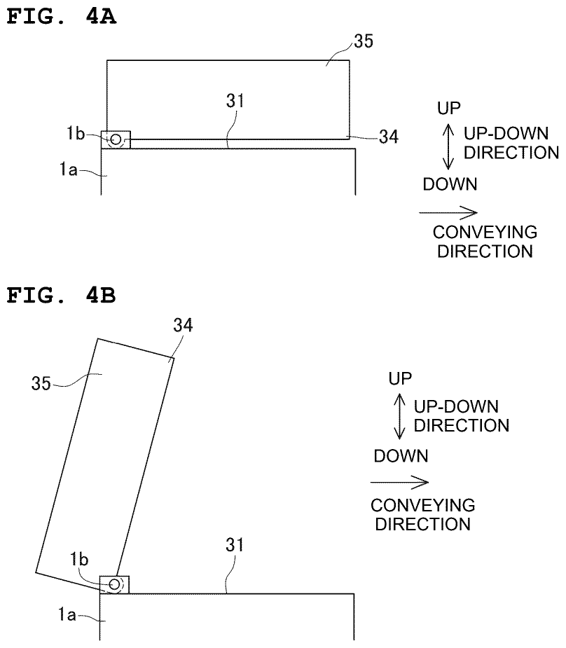

As depicted in FIGS. 3, 4A and 4B, the reading part 5 includes a placement stand 31, a reading unit 33, a cover 34 and an Auto Document Feeder 35 (hereinafter referred to as “ADF 35”).

The placement stand 31 is a member made of a transparent material such as glass and having a substantially rectangular parallelepiped shape, and is disposed in an upper part of the recording apparatus 1.

The reading unit 33 is located below the placement stand 31. The reading unit 33 includes a second carriage 41, a light-emitting part 42, and a plurality of light-receiving parts 43.

The second carriage 41 extends over the entire length of the placement stand 31 in the conveying direction. Further, the second carriage 41 is supported by a non-illustrated guide rail so as to be movable in the scanning direction. Furthermore, the second carriage 41 is connected to a second carriage motor 88 depicted in FIG. 5 via a non-illustrated belt, etc. In a case where the controller 80 drives the second carriage motor 88, the second carriage 41 moves in the scanning direction along the non-illustrated guide rail.

The light-emitting part 42 is disposed in the upper surface of the second carriage 41. The light-emitting part 42 irradiates lights of three colors which are red, green, and blue, toward the placement stand 31. The plurality of light-receiving parts 43 are disposed in the upper surface of the second carriage 41. The plurality of light-receiving parts 43 are disposed adjacent to each other in the conveying direction over the entire length of the placement stand 31. Each of the plurality of light-receiving parts 43 receives the light which is irradiated from the light-emitting part 42 and reflected by an original R1 placed on the placement stand 31, or an original R2 conveyed by the ADF 35 as will be described later. Each of the plurality of light-receiving parts 43 individually detects the red, green, and blue components of the received light, and outputs a signal according to the components of the respective colors.

The cover 34 is positioned above the placement stand 31. The cover 34 is supported to be rockable by a rocking shaft 1b. The rocking shaft 1b is disposed at an end part, on the upstream side in the conveying direction, of an upper end part of a casing 1a of the recording apparatus 1, and extends in the scanning direction. Further, the cover 34 is movable between a closed position at which the cover 34 covers the placement stand 31 as depicted in FIG. 4A and an open position at which the cover 34 exposes the placement stand 31 as depicted in FIG. 4B, by rocking about the rocking shaft 1b.

The ADF 35 is positioned in the cover 34. In a case where the cover 34 is located at the closed position, the ADF 35 is located above a left end part of the placement stand 31. The ADF 35 includes an original set part 51, a supplying roller 52, a guide route 53, and a discharging roller 54.

The original set part 51 is a part in which the original R2 is set. A single original R2 or a plurality of originals R2 stacked in the up-down direction can be set in the original set part 51. The supplying roller 52 is positioned on the left side of the original set part 51. The supplying roller 52 is connected to an ADF motor 89 depicted in FIG. 5 via a non-illustrated gear, etc. In a case where the controller 80 drives the ADF motor 89, the supplying roller 52 rotates to thereby convey the original R2 set in the original set part 51 to the left side in the scanning direction. In a case where the plurality of originals R2 stacked in the up-down direction are set in the original set part 51, an original R2 located the lowermost among the plurality of originals R2 is conveyed by the supplying roller 52.

The guide route 53 guides the original R2 conveyed by the supplying roller 52. To provide a more detailed description, the guide route 53 is an arc-shaped path as seen from the conveying direction. The original R2 conveyed to the left side of the scanning direction by the supplying roller 52 is guided by the guide route 53, whereby the orientation of conveyance of the original R2 is changed downward, and then the orientation of conveyance of the original R2 is changed to the rightward in the scanning direction. Then, original R2 fed out from the guide route 53 is conveyed to the right side of the scanning direction, at a location immediately above the placement stand 31.

The discharging roller 54 is connected to the ADF motor 89 depicted in FIG. 5 via a non-illustrated gear, etc. In a case where the controller 88 drives the ADF motor 89, the discharging roller 54 rotates so as to convey the original R2 fed out from the guide route 53 to the right side of the scanning direction and to discharge the original R2 to the discharging part 55 disposed in the upper surface of the cover 34.

Further, in the recording apparatus 1, in a state that the original R1 is placed on the placement stand 31, the controller 88 causes the reading unit 33 to irradiate the lights from the light-emitting part 42 towards the placement stand 31, while the controller 88 controls the second carriage motor 88 to thereby cause the second carriage 41 to move in the scanning direction, as depicted by solid lines in FIG. 3. With this, the reading part 5 of the recording apparatus 1 can read the original R1 placed on the placement stand 31.

Furthermore, in a state that the reading unit 33 is positioned immediately below the ADF 35 as depicted by dashed lines in FIG. 3 and that the original R2 is set in the original set part 51, the controller 80 causes the reading unit 33 to irradiate the lights from the light-emitting part 42 toward the placement stand 31, while the controller 80 controls the ADF motor 89 to convey the original R2 by the supplying roller 52 and the discharging roller 54. With this, the reading part 5 of the recording apparatus 1 can read the original R2 which is being conveyed immediately above the placement stand 31.

Further, a partition wall 36 overlapping with the placement stand 31 in the up-down direction is positioned below the reading unit 33. The partition wall 36 separates a space in the recording apparatus 1 in which the reading unit 33 is disposed from another space in the recording apparatus 1 in which the ink-jet head 12 and the like are disposed.

### Electric Configuration of Recording Apparatus

Next, the electrical configuration of the recording apparatus 1 will be described. As depicted in FIG. 5, the recording apparatus 1 includes a controller 80. The controller 80 includes a CPU 81, a ROM 82, a RAM 83, a memory 84, an ASIC 85, and the like.

The controller 80 controls the operation of each of the conveyor 3, the first carriage motor 86, the ink-jet head 12, the conveying motor 87, the second carriage motor 88, the light-emitting part 42, the ADF motor 89, the operation panel 6, etc. Further, the controller 80 receives a signal from each of the operation panel 6 and the plurality of light-receiving parts 43. Furthermore, in the present embodiment, an external memory 91 is detachably attached to the recording apparatus 1.

Moreover, in the present embodiment, the recording apparatus 1 includes a communicating part 90. The recording apparatus 1 is capable of communicating with an external server 100, via the communicating part 90. The server 100 includes a controller 101, a communicating part 102, and the like. The controller 101 includes a CPU 111, a ROM 112, a RAM 113, a memory 114, and the like, and performs a process related to an additional function which will be described later. The communicating part 102 is connected to the communicating part 90 of the recording apparatus 1 via the network 99 which is, for example, the Internet, etc. Further, in a state that the communicating part 90 of the recording apparatus 1 and the communicating part 102 of the server 100 are connected, transmission can be made between the recording apparatus 1 and the server 100. Note that in the present embodiment, the server 100 corresponds to an “external apparatus” of the present disclosure.

Further, in the present embodiment, an external terminal 92 is connected to the communicating part 90 of the recording apparatus 1 via the network 99. The external terminal 92 is a PC, a tablet terminal, a smartphone, etc., and is a device having a display 93 and an operating part 94. In a case where the external terminal 92 is the PC, the display 93 is a liquid crystal display, etc., and the operating part 94 is a keyboard, a mouse, etc. In a case where the external terminal 92 is the tablet terminal or the smartphone, a touch panel of the tablet terminal or the smartphone is the display 93 and the operating part 94. Although the external terminal 92 also has a communicating part and a controller which includes a CPU, a ROM, RAM, a memory, etc., these constituent components are omitted from FIG. 5.

In the present embodiment, the recording apparatus 1, the server 100, and the external terminal 92 are connected via the network 99 to thereby construct a recording system 70.

Note that in the controller 80 of the recording apparatus 1, only the CPU 81 may perform various processes or only the ASIC 85 may perform the various processes, or the CPU 81 and the ASIC 85 may perform the various processes in a cooperative manner. Alternatively, in the controller 80, one CPU 81 may singly perform a process, or a plurality of CPUs 81 may perform the process in a sharing manner. Still alternatively, in the controller 80, one ASIC 85 may singly perform a process, or a plurality of ASICs 85 may perform the process in a sharing manner. Further, in the controller 101 of the server 100, one CPU 111 may singly perform a process, or a plurality of CPUs 111 may perform the process in a sharing manner. This is applicable similarly to a non-illustrated controller of the external terminal 92 as well.

### Main Screen

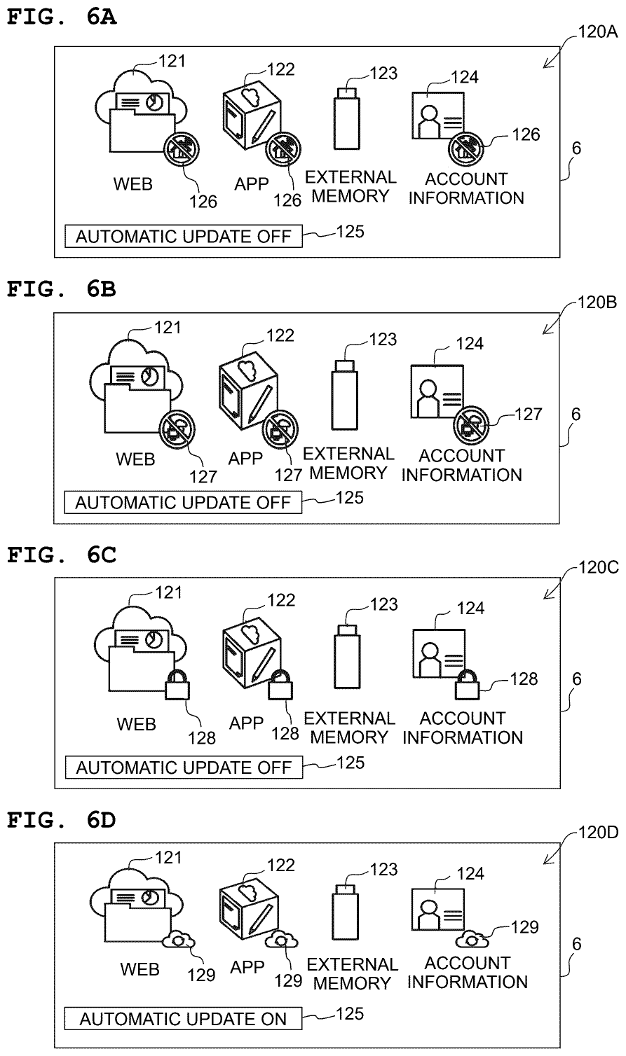

In a case where the recording apparatus 1 is in a standby state wherein the recording apparatus 1 is not performing recording on the sheet S, reading of the original by the reading part 5, etc., and where the recording apparatus 1 is not connected to the network 99, the controller 80 causes the display panel 6 to display a main screen 120A depicted in FIG. 6A. Further, in a case where the recording apparatus 1 is in the standby state and where although the recording apparatus 1 is connected to the network 99, the recording apparatus is not ready for communicating with the server 100, the controller 80 causes the display panel 6 to display a main screen 120B depicted in FIG. 6B.

Furthermore, in a case where the recording apparatus 1 is in the standby state, where the recording apparatus 1 is ready for communicating with the server 100, and where the account registration has not been made, the controller 80 causes the display panel 6 to display a main screen 120C depicted in FIG. 6C. Moreover, in a case where the recording apparatus 1 is in the standby state, where the recording apparatus 1 is ready for communicating with the server 100, and where the account registration has been made, the controller 80 causes the display panel 6 to display a main screen 120D depicted in FIG. 6D. Here, information indicating whether the account registration has been made or not is stored in the memory 84 of the recording apparatus 1 or in the memory 114 of the server 100. In a case where the recording apparatus 1 is ready for communicating with the server 100, the controller 80 causes the operation panel 6 to display either the main screen 120C or the main screen 120D, based on the information on whether the account registration has been made or not.

Each of the main screens 120A to 120D includes a web selecting part 121, an application function selecting part 122, an external memory selecting part 123, an account information selecting part 124, and an update selecting part 125. The respective selecting parts 121 to 125 of each of the screens 120A to 120D displayed on the operation panel 6 are each displayed in a selectable state unless otherwise described specifically.

In each of the main screens 120A and 120B, the web selecting part 121, the application function selecting part 122, and the account information selecting part 124 are displayed in a non-selectable state. In the main screen 120A, each of the web selecting part 121, the application function selecting part 122, and the account information selecting part 124 includes a network-unconnected icon 126. Further, the network-unconnected icon 126 indicates that the function indicated by each of the web selecting part 121, the application function selecting part 122, and the account information selecting part 124 is an additional function (to be described later), that the recording apparatus 1 is not connected to the network 99, and that the function is in the non-selectable state. In the main screen 120B, each of the web selecting part 121 and the application function selecting part 122 includes a server-unconnected icon 127. The server-unconnected icon 127 indicates that the function indicated by each of the web selecting part 121 and the application function selecting part 122 is the additional function (to be described later), that the recording apparatus 1 is not ready for communicating with the server 100, and that the function is in the non-selectable state.

In the main screen 120C, each of the web selecting part 121, the application function selecting part 122, and the account information selecting part 124 is displayed in a state that the additional function (to be described later) indicated by each of the web selecting part 121, the application function selecting part 122, and the account information selecting part 124 cannot be executed even in a case where the function is selected. In the main screen 120C, each of the web selecting part 121 and the application function selecting part 122 includes a key icon 128 which indicates that the function indicated by each of the web selecting part 121 and the application function selecting part 122 is the additional function and that in a state that the additional function cannot be executed.

In the main screen 120D, each of the web selecting part 121, the application function selecting part 122, and the account information selecting part 124 is displayed in a state that the additional function indicated by each of the web selecting part 121, the application function selecting part 122, and the account information selecting part 124 can be executed in a case where the function is selected. In the main screen 120D, each of the web selecting part 121, the application function selecting part 122, and the account information selecting part 124 includes a cloud icon 129 which indicates that the function indicated by each of the web selecting part 121, the application function selecting part 122, and the account information selecting part 124 is the additional function and that in a state that the additional function can be executed by being selected.

Next, the operation in a case where each of the selecting parts in one of the main screens 120A to 120D is selected will be described.

Even in a case where each of the web selecting part 121, the application function selecting part 122, and the account information selecting part 124 is selected in the main screens 120A and 120B, the controller 80 does not execute any process, and the screen displayed on the operation panel 6 also does not change. Alternatively, in a case where each of the web selecting part 121, the application function selecting part 122, and the account information selecting part 124 is selected in the main screen 120A, the controller 80 may cause the operation panel 6 to display a screen including a message indicating that the recording apparatus 1 is not connected to the network 99. Further, in a case where each of the web selecting part 121, the application function selecting part 122, and the account information selecting part 124 is selected in the main screen 120B, the controller 80 may cause the operation panel 6 to display a screen including a message indicating that the recording apparatus 1 is not ready for communicating with the server 100.

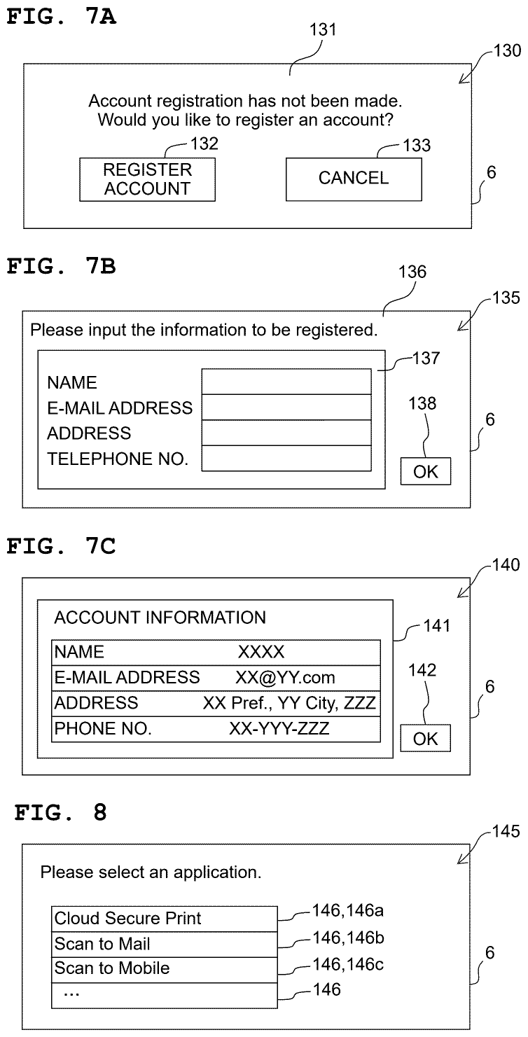

In a case where any of the web selecting part 121, the application function selecting part 122, and the account information selecting part 124 is selected in the main screen 120C, the controller 80 causes the operation panel 6 to display an unregistered account screen 130 depicted in FIG. 7A. The unregistered account screen 130 includes a message part 131, a registration start selecting part 132, and a cancelation selecting part 133.

The message part 131 displays a message indicating that the account registration has not been made, and a message inquiring whether to perform the account registration. The cancelation selecting part 133 is a part selected by the user so as to cancel the account registration. In a case where the cancelation selecting part 133 is selected, the controller 80 returns the display of the operation panel 6 to the main screen 120C. The registration start selecting part 132 is a part selected by the user so as to start account registration. In a case where the registration start selecting part 132 is selected, the controller 80 causes the operation panel 6 to display an input screen 135 depicted in FIG. 7B.

The input screen 135 includes a message part 136, an input part 137, and an input completion selecting part 138. The message part 136 displays a message which prompts the user to input information into the input part 137. The input part 137 is a part to which information required for the account registration is input. FIG. 7B depicts, as an example, a case where the items to be input into the input part 137 are a name, an email address, an address, and a telephone number. Further, for example, in a case where the input part 137 is selected, a non-illustrated keyboard may be displayed on the operation panel 6, and the user may operate this keyboard so as to input the information into the input part 137.

The input completion selecting part 138 is a part selected by the user in a case where the input into the input section 137 is completed. In a case where the input completion selecting part 138 is selected in a state that the input into the input section 137 is completed, the controller 80 transmits an approval signal including the information input into the input section 137 to the server 100. In a case the controller 101 of the server 100 receives the approval signal, the controller 101 executes a process of the account registration based on the approval signal, and after the completion of the process of the account registration, the controller 101 transmits, to the recording apparatus 1, a response signal indicating that the process of the account registration is completed. In a case where the controller 80 of the recording apparatus 1 receives the response signal, the controller 80 causes the operation panel 6 to display the main screen 120D. With this, each of the web selecting part 121, the application function selecting part 123 and the account information selecting part 124 is switched from being in a state that selection for executing the additional function cannot be executed to being in a state that the selection for executing the additional function can be executed.

Note that the account registration is not limited to being performed by the operation of the operation panel 6. For example, in a case where the registration start selecting part 132 is selected, an image describing the URL of a site at which the account registration is to be performed, etc., may be recorded on the sheet S, and the account registration may be performed by the user operating the operating part 94 of the external terminal 92, according to the description in this image. In this situation, for example, in a case where the account registration is completed, a PIN code may be displayed on the display 93 of the external terminal 92. Then, in a case where an operation of inputting this PIN code is performed in the operation panel 6, an approval signal may be transmitted from the recording apparatus 1 to the server 100.

In a case where the account information selecting part 124 is selected in the main screen 120D, the controller 80 causes the operation panel 6 to display a registration content confirming screen 140 depicted in FIG. 7C. The registration content confirming screen 140 has an information displaying part 141 and an end selecting part 142. The information displaying part 141 displays the information registered as the account information. FIG. 7C depicts a case where the information registered as the account information is the name, the email address, the address, and the telephone number. The end selecting part 142 is a part selected by the user so as to end the display of the account information. In a case where the end selecting part 142 is selected, the controller 80 returns the screen displayed on the operation panel 6 to the main screen 120D.

In a case where the web selecting part 121 is selected in the main screen 120D, the controller 80 causes the operation panel 6 to display, for example, a screen via which image data stored in the memory 114 of the server 100 is selected; in a case where the image data is selected in this screen, the controller 80 controls the conveyor 3 to feed the sheet S to the recording part 2 and controls the ink-jet head 12, the conveying motor 87, etc. to repeatedly perform the recording pass and the conveying operation. With this, the controller 80 causes the ink-jet head 12 to record an image corresponding to the selected image data on the sheet S. However, any further detailed description of the operation in a case where the web selecting part 121 is selected in the main screen 120D will be omitted.

In a case where the application function selecting part 122 is selected in the main screen 120D, the controller 80 causes the operation panel 6 to display an application selecting screen 145 depicted in FIG. 8. The application selecting screen 145 has a plurality of application selecting parts 146. Each of the plurality of application selecting parts 146 is a part selected by the user to select an application. The plurality of application selecting parts 146 includes a first application selecting part 146a, a second application selecting part 146b, and a third application selecting part 146c.

The first application selecting part 146a is a part selected by the user to select a first application. The first application is an application of which name in the FIG. 7 is “Cloud Secure Print” which executes a function of performing, in the recording apparatus 1, the recording of an image of image data stored in the external terminal 92 while ensuring the confidentiality of the data.

The second application selecting part 146b is a part selected by the user to select a second application. The second application is an application of which name in FIG. 8 is “Scan to Mail” which executes a function of sending image data of an image read in the reading part 5 to a specified email address.

The third application selecting part 146c is a part selected by the user to select a third application. The third application is an application of which name in FIG. 8 is “Scan to Mobile” which executes a function of storing, in the external terminal 92, image data of an image read in the reading part 5.

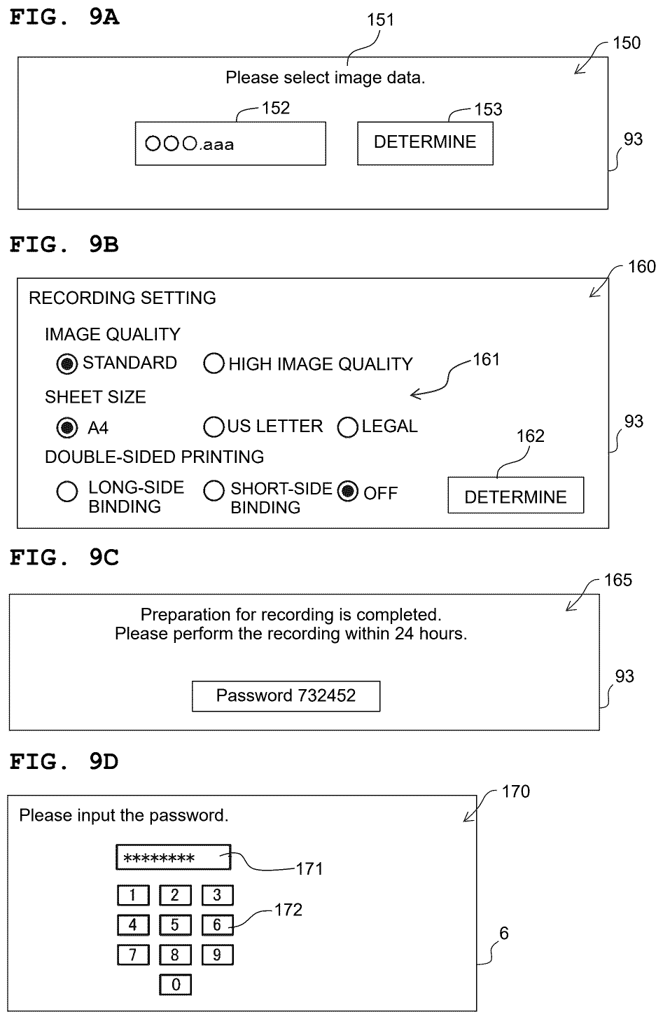

Next, the function of the first application will be described in detail. In a case where the operating part 94 of the external terminal 92 is operated by the user so as to connect the external terminal 92 to a predetermined site in the server 100, the controller 101 of the server 100 causes the display 93 of the external terminal 92 to display an image data selecting screen 150 depicted in FIG. 9A. The image data selecting screen 150 includes a message part 151, an input part 152, and a determination selecting part 153. The message part 151 displays a message prompting the user to perform selection of image data of an image to be recorded. The input part 152 is a part for inputting the image data of the image to be recorded. The image data can be input to the input part 152 by the operation of the operating part 94 of the external terminal 92. The determination selecting part 153 is a part selected by the user in a case where the user decides to perform the recording of the image data input to the input part 152.

In a case where the determination selecting part 153 is selected in a state that the image data is input in the input part 152, the controller 101 of the server 100 causes the display 93 of the external terminal 92 to display a recording setting screen 160 depicted in FIG. 9B. The recording setting screen 160 includes a setting selecting part 161 and a determination selecting part 162. The setting selecting part 161 is a part for making the setting related to the image to be recorded. The setting selecting part 161 allows the user to perform, for example, the setting such as the image quality of the image to be recorded, the size of the sheet S, and double-sided recording, etc., by the operation of the operating part 94 of the external terminal 92. The determination selecting part 162 is a part selected by the user in a case where determination is made regarding the setting in the setting selecting part 161.

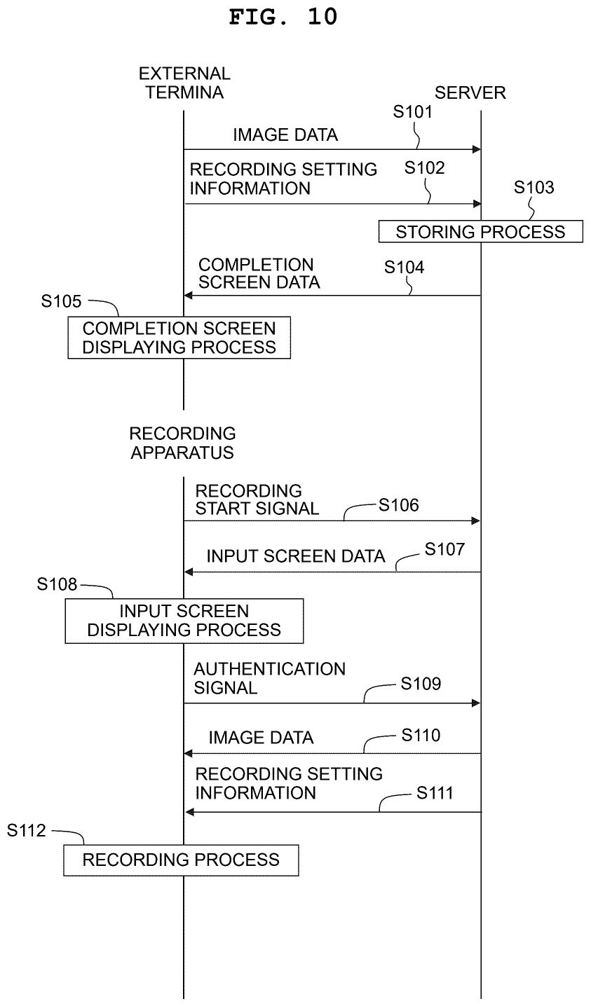

In a case where the determination selecting part 162 is selected in a state that the respective settings are made in the setting selecting part 161, the image data selected in the image data selecting screen 150 and recording setting information set in the recording setting screen 160 are transmitted from the external terminal 92 to the server 100 (steps S101 and S102), as depicted in FIG. 10. The controller 101 of the server 100 executes a storing process of causing the memory 114 to store the image data and the recording setting information which have been received (step S103).

Next, the controller 101 of the server 100 transmits completion screen data, which is data of a completion screen 165 to be described next, to the external terminal 92 (step S104). In a case where the external terminal 92 receives the completion screen data, the external terminal 92 executes a completion screen displaying process (step S105). In the completion screen displaying process of step S105, the external terminal 92 causes the display 93 to display a completion screen 165 as depicted in FIG. 9C, based on the completion screen data. The completion screen 165 displays a message indicating that the preparation for recording by the function of the first application has been completed, a message indicating a period of validity (for performing the recording), a password, etc.

After the completion screen 165 is displayed in the display 93 of the external terminal 92, in a case where the first application selecting part 146a of the application selecting screen 145 is selected in the recording apparatus 1, a recording start signal is transmitted from the recording apparatus 1 to the server 100 (step S106). In a case where the controller 101 of the server 100 receives the recording start signal, the controller 101 transmits input screen data, which is data of an input screen 170 to be described next, to the recording apparatus 1 (step S107). In a case where the controller 80 of the recording apparatus 1 receives the input screen data, the controller 80 executes an input screen displaying process (step S108). In the input screen displaying process of step S108, the controller 80 of the recording apparatus 1 causes the operation panel 6 to display the input screen 170 as depicted in FIG. 9D, based on the input screen data.

The input screen 170 includes a password input part 171 and a plurality of input buttons 172. The password input part 171 is a part to which the password displayed on the above-described completion screen 165 is input. The plurality of input buttons 172 is, for example, ten buttons numbered 0 to 9, and in a case where each of the plurality of input buttons 172 is selected, a value corresponding to each of the selected input buttons is input to the password input part 171.

In a case where the password displayed on the completion screen 165 is input into the password input part 171 by selecting the input buttons 172 within the period of validity displayed on the completion screen 165, an authentication signal is transmitted from the recording apparatus 1 to the server 100 (step S109). In a case where the controller 101 of the server 100 receives the authentication signal, the controller 101 transmits the image data and the recording setting information stored in the memory 114 to the recording apparatus 1 (step S110 and step S111). In a case where the controller 80 of the recording apparatus 1 receives the image data and the record setting information, the controller 80 executes a recording process (step S112). In the recording process of step S112, the controller 80 of the recording apparatus 1 controls the conveyor 3 so as to feed the sheet S to the recording part 2, and controls the ink-jet head 12, the conveying motor 87, etc., so as to repeatedly perform the recording pass and the conveying operation. With this, the controller 80 causes the recording part 2 to record, on the sheet S, an image corresponding to the image data selected in the image data selecting screen 150 based on the recording setting set in the recording setting screen 160.

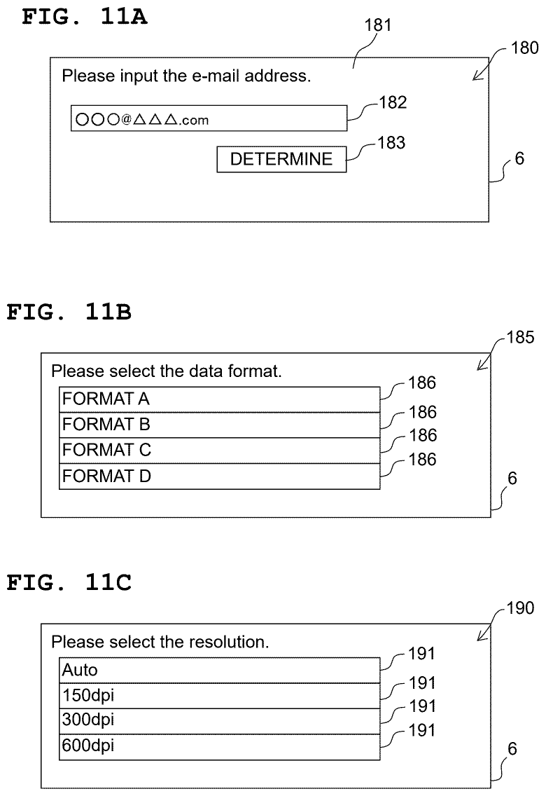

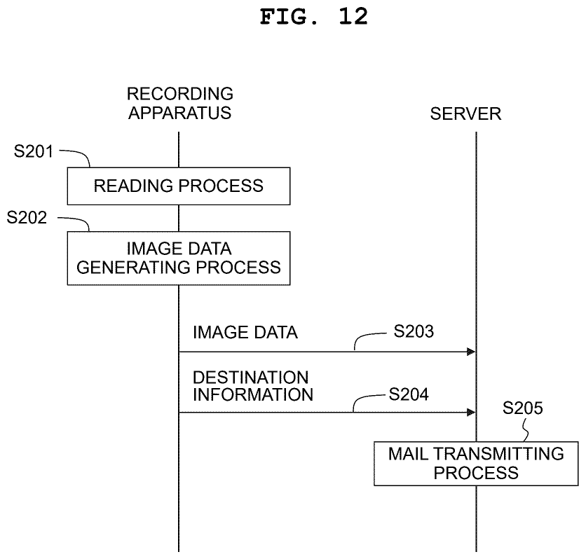

Next, the function of the second application will be described in detail. In a case where the second application selecting part 146b of the application selecting screen 145 is selected, the controller 80 causes the operation panel 6 to display a destination setting screen 180 depicted in FIG. 11A. The destination setting screen 180 includes a message part 181, an address input part 182, and a determination selecting part 183.

A message prompting the user to input a destination mail address is displayed in the message part 181. The address input part 182 is a part to which the destination mail address is input. For example, in a case where the address input part 182 is selected, a non-illustrated keyboard may be displayed on the operation panel 6, and the destination mail address may be input into the address input part 182 by operating this keyboard. The determination selecting part 183 is a part selected by the user in a case where the mail address input into the address input part 182 is determined as the delivery destination.

In a case where the determination selecting part 183 is selected in a state that the email address has been input in the address input part 182, the controller 80 causes the operation panel 6 to display a data format selecting screen 185 depicted in FIG. 11B. The data format selecting screen 185 includes a plurality of data format selecting parts 186. Each of the plurality of data format selecting parts 186 is a part selected by the user to select the data format of the image data to be transmitted.

In a case where any one of the plurality of data format selecting parts 186 is selected, the controller 80 causes the operation panel 6 to display a resolution selecting screen 190 depicted in FIG. 11C. The resolution selecting screen 190 includes a plurality of resolution selecting parts 191. Each of the plurality of resolution selecting parts 191 is a part selected by the user to select the resolution at which the image is read by the reading part 5. Note that “Auto” in FIG. 11C is a mode of causing the controller 80 to automatically select the resolution.

In a case where any one of the plurality of resolution selecting parts 191 is selected, the controller 80 of the recording apparatus 1 executes a reading process (step S201) as depicted in FIG. 12. In the reading process of step S201, the controller 80 of the recording apparatus 1 controls the second carriage motor 88, the light-emitting part 42, etc., so as to cause the reading part 33 to read the original R1 placed on the placement stand 31. Alternatively, the controller 80 controls the second carriage motor 88, the light-emitting part 42, the ADF motor 89, etc., so as to cause the ADF 35 to feed the original R2, and to cause the reading part 33 read the fed original R2. In this situation, the controller 80 causes the reading unit 33 to read the original R1 or the original R2 at the resolution selected in the resolution selecting screen 190.

Next, the controller 80 executes an image data generating process of generating image data of the data format selected in the data format selecting screen 185 from the read data of the original R1 or the original R2 (step S202). Next, the controller 80 of the recording apparatus 1 transmits, to the server 101, the generated image data and destination information which is information regarding the destination set in the destination setting screen 180 (step S203 and step S204). In a case where the controller 101 of the server 100 receives the image data and the destination information, the server 101 executes a mail transmitting process of transmitting an e-mail, with the received image data attached thereto, to the address indicated by the received destination information (step S205).

Note that, in the present embodiment, the controller 80 of the recording apparatus 1 generates the image data from the read data as described above. However, for example, the recording apparatus 1 may transmit, to the server 100, the image data and the information regarding the data format selected in the data format selecting screen 185, and the controller 101 of the server 100 may generate the image data from the read data.

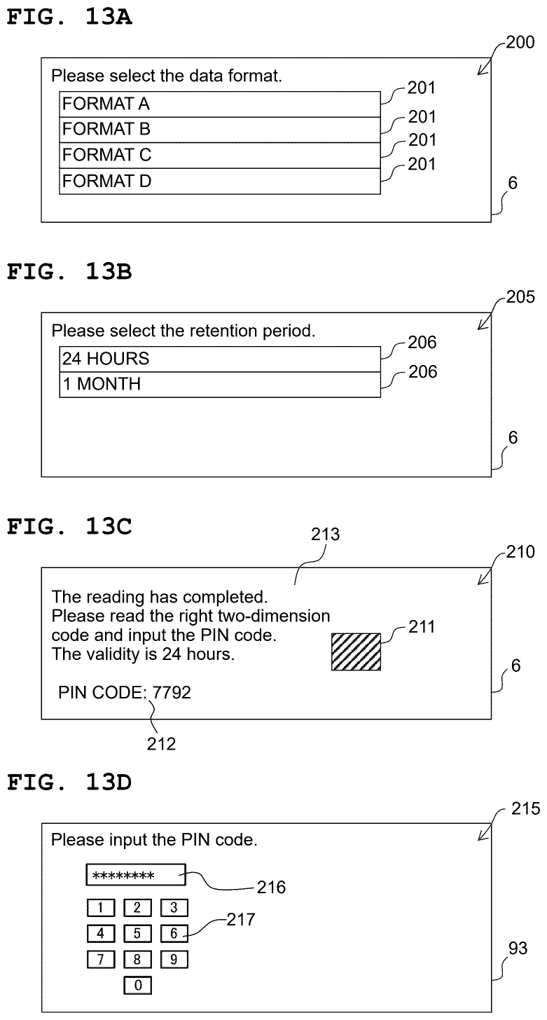

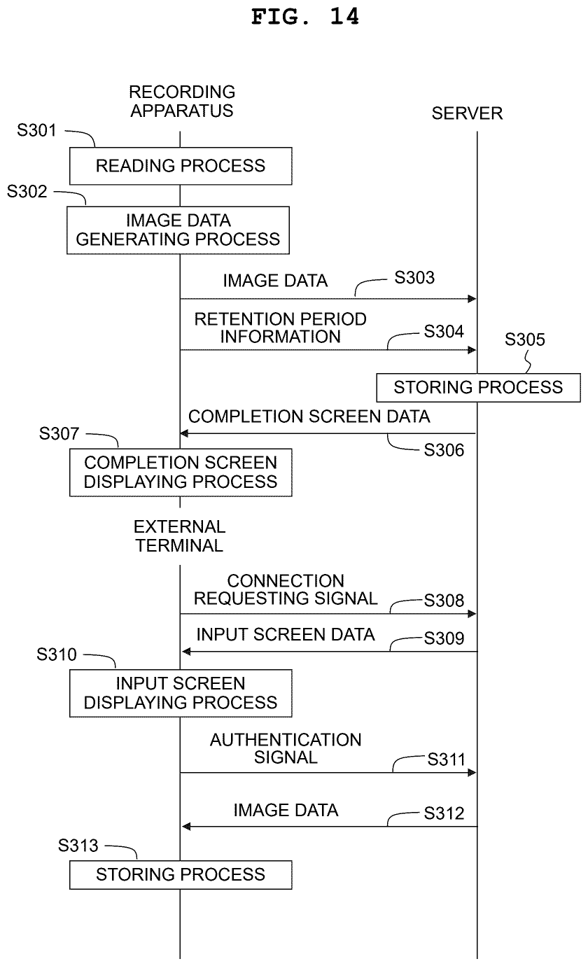

Next, the function of the third application will be described in detail. In a case where the third application selecting part 146c of the application selecting screen 145 is selected, the controller 80 causes the operation panel 6 to display a data format selecting screen 200 depicted in FIG. 13A. The data format selecting screen 200 has a plurality of data format selecting parts 201. Each of the plurality of data format selecting parts 201 is a part selected by the user so as to select the data format of image data to be stored. The data formats indicated by the plurality of data format selecting parts 201 may be the same as the data formats indicated by the plurality of data format selecting parts 186 described above, or at least a part of the data formats indicated by the plurality of data format selecting parts 201 may be different from the data formats indicated by the plurality of data format selecting parts 186.

In a case where any one of the plurality of data format selecting parts 201 is selected, the controller 80 causes the operation panel 6 to display a retention period selecting screen 205 depicted in FIG. 13B. The retention period selecting screen 205 includes a plurality of retention period selecting parts 206. Each of the plurality of retention period selecting parts 206 is a part selected by the user so as to select a retention period during which image read in the reading part 5 is to be stored in the server 100.

In a case where any one of the plurality of retention period selecting parts 206 is selected, the controller 80 of the recording apparatus 1 executes a reading process similar to step S201 (step S301) as depicted in FIG. 14, and then executes an image data generating process of generating image data of the data format selected in the data format selecting screen 200, from the read data of the original R1 or the original R2 (step S302). Next, the controller 80 of the recording apparatus 1 transmits, to the server 100, the generated image data and retention period information which is information on the retention period set in the retention period setting screen 205 (step S303 and step S304). Note that, in the present embodiment, the controller 80 of the recording apparatus 1 generates the image data from the read data as described above. However, for example, the controller 80 of the recording apparatus 1 may transmit, to the server 100, the image data and the information on the data format selected in the data format selecting screen 200, and the controller 101 of the server 100 may generate the image data from the read data.

In a case where the controller 101 of the server 100 receives the image data and the retention period information, the controller 101 executes a storing process of causing the memory 114 to store the received image data (step S305). Then, the controller 101 of the server 100 maintains a state that the image data is stored in the memory 114 for the retention period indicated by the retention period information.

Next, the controller 101 of the server 100 transmits, to the recording apparatus 1, completion screen data for displaying a completion screen 210 which will be described next (step S306). Upon receiving the completion screen data, the controller 80 of the recording apparatus 1 executes a completion screen displaying process of causing the operation panel 6 to display the completion screen 210 depicted in FIG. 13C, based on the completion screen data (step S307).

The completion screen 210 includes a two-dimensional code displaying part 211, a PIN code displaying part 212, and a message part 213. The two-dimensional code displaying part 211 displays a two-dimensional code for accessing the site, of the server 100, in which the image data is stored. The PIN code displaying part 212 displays a PIN code for accessing the image data at the site. The message part 213 displays a message indicating that the reading has been completed and prompting the user to read the two-dimensional code to connect to the site and then to input the PIN code to thereby store the image data.

Here, the external terminal 92 has a camera, a code reader, etc., which are not depicted and configured to read the two-dimensional code. Then, in a case where the external terminal 92 reads the two-dimensional code displayed in the two-dimensional code displaying part 211, the external terminal 92 transmits a connection requesting signal to the server 100 (step S308). In a case where the controller 101 of the server 100 receives the connection requesting signal, the server 101 transmits, to the external terminal 92, input screen data, which is data of an input screen 215 to be described next (step S309). In a case where the external terminal 92 receives the input screen data, the external terminal 92 executes an input screen displaying process of causing the display 93 to display an input screen 215 as depicted in FIG. 13D, based on the input screen data (step S310).

The input screen 215 includes a PIN code input part 216 and a plurality of input buttons 217. The PIN code input part 216 is a part into which the PIN code displayed on the completion screen 210 described above is input. The plurality of input buttons 217 is, for example, ten buttons numbered 0 to 9, and in a case where each of the plurality of input buttons 217 is selected, a value corresponding to each of the selected input buttons is input into the PIN code input part 216.

In a case where input buttons 217 among the plurality of input buttons 217 are selected by the operation of the operating part 94 of the external terminal 92 and the PIN code displayed on the completion screen 210 is input to the PIN code input part 216 within the period of validity displayed on the completion screen 210, an authentication signal is transmitted from the external terminal 92 to the server 100 (step S311). In a case where the controller 101 of the server 100 receives the authentication signal, the controller 101 transmits the image data stored in the memory 114 to the recording apparatus 1 (step S312). In a case where the external terminal 92 receives the image data, the external terminal 92 executes a storing process of storing the received image data (step S313).

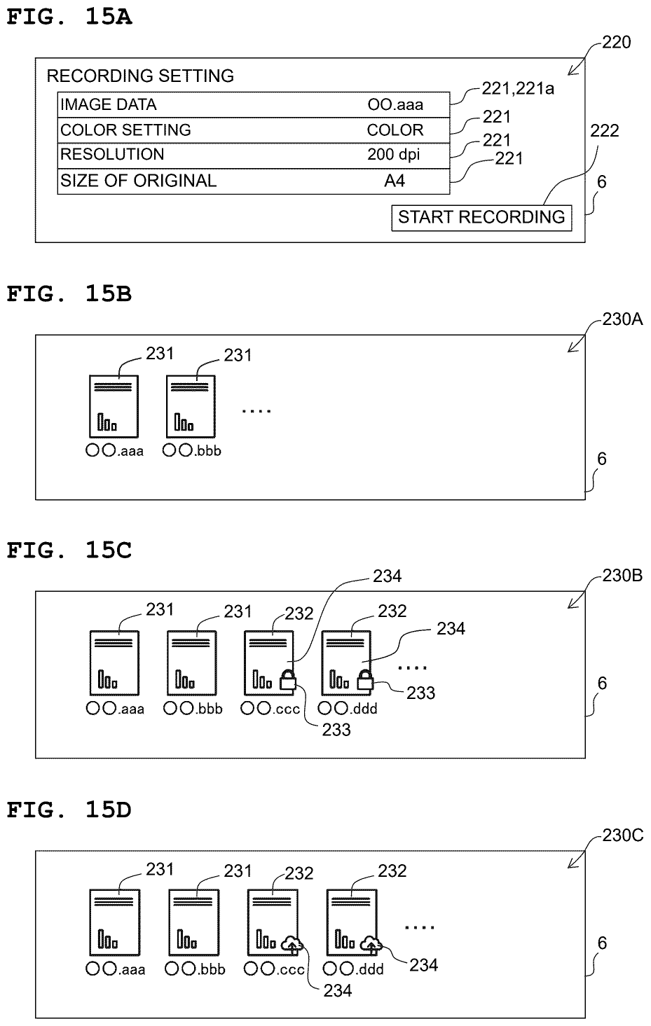

Returning to FIGS. 6A to 6D, the external memory selecting part 123 of each of the main screens 120A to 120D is a part which is selected by the user so as to execute a function of performing, in the recording apparatus 1, recording of an image corresponding to image data stored in the external memory 91. In a case where the external memory selecting part 123 is selected in each of the main screens 120A to 120D, the controller 80 causes the operation panel 6 to display a recording setting screen 220 depicted in FIG. 15A.

The recording setting screen 220 has a plurality of recording setting selecting parts 221 and a recording start selecting part 222. Each of the plurality of recording setting selecting parts 221 is a part selected by the user so as to select a setting item regarding the recording.

The plurality of recording setting selecting parts 221 includes an image data selecting part 221a for selecting image data of an image to be recorded. Further, as depicted in FIG. 15A, the plurality of recording setting selecting parts 221 may include, for example, a recording setting selecting part 221 for setting whether to read the image as a color image or a monochromatic image. Furthermore, the plurality of recording setting selecting parts 221 may include, for example, a recording setting selecting part 221 for setting the resolution of the recording. Moreover, the plurality of recording setting selecting parts 221 may include, for example, a recording setting selecting part 221 for setting the size of a sheet S on which an image is to be recorded. Note that, due to a low relevance to the characteristics of the present disclosure, any detailed description of the operation in a case where each of the recording setting selecting parts 221, other than the image data selecting part 221a, is selected will be omitted.

The recording start selecting part 222 is a part selected by the user so as to start the recording of the image corresponding to the image data stored in the external memory 91. The operation in a case where the recording start selecting part 222 is selected will be described in detail later.

In a case where the image data selecting part 221a is selected in a state that the recording apparatus 1 is not ready for communicating with the server 100, the controller 80 causes the operation panel 6 to display an image data selecting screen 230A depicted in FIG. 15B. The image data selecting screen 230A has a first image data selecting part 231. The first image data selecting part 231 is a part selected by the user so as to select image data of a first data format with which the controller 80 of the recording apparatus 1 can generate ejection data, for ejecting the ink(s) from the plurality of nozzles 10, based on the image data from among the image data stored in the external memory 91, etc. In FIG. 15B, for example, image data with an extension “aaa” and image data with an extension “bbb” are each the image data of the first data format.

In a case where the image data selecting part 221a is selected in a state that the recording apparatus 1 is ready for communicating with the server 100 and that the account registration has not been made, the controller 80 causes the operation panel 6 to display an image data selecting screen 230B depicted in FIG. 15C. The image data selecting screen 230B has a second image data selecting part 232, in addition to a first image data selecting part 231 which is similar to the first image data selecting part 231 of the image data selecting screen 230A in FIG. 15B. The second image data selecting part 232 is a part selected by the user so as to select image data of a second data format with which the controller 80 of the recording apparatus 1 cannot generate ejection data based on the image data from among the image data stored in the external memory 91, whereas with which the controller 101 of the server 100 can generate the ejection data based on the image data from among the image data stored in the external memory 91. In FIG. 15C, for example, image data with an extension “ccc” and image data with an extension “ddd” are each the image data of the second data format.

Note, however, that in the image data selecting screen 230B, the second image data selecting part 232 is displayed in a non-selectable state on the operation panel 6. Here, in the image data selecting screen 230B, the second image data selecting part 232 includes a key icon 233. The key icon 233 indicates that the second image data selecting part 232 is non-selectable and that the recording apparatus 1 cannot execute an additional function of recording an image based on the image data of the second data format.

In a case where the image data selecting part 221a is selected in a state that the recording apparatus 1 is ready for communicating with the server 100 and that the account registration has been made, the controller 80 causes the operation panel 6 to display an image data selecting screen 230C depicted in FIG. 15D. The image data selecting screen 230C has a first image data selecting part 231 and a second image data selecting part 232 similar to the first image data selecting part 231 and the second image data selecting part 232 of the image data selecting screen 230B of FIG. 15C.

Note, however, that in the image data selecting screen 230C, the second image data selecting part 232 is displayed in a selectable state on the operation panel 6. Further, in the image data selecting screen 230C, the second image data selecting part 232 does not include the key icon 233, but includes a cloud icon 234. Furthermore, since the second image data selecting part 232 includes the cloud icon 234, the second image data selecting part 232 is indicated as being selectable, and the recording apparatus 1 is indicated as being capable of executing the additional function of recording an image based on the image data of the second data format.

In a case where any one of the first image data selecting parts 231 is selected in each of the image data selecting screens 230A to 230C, and in a case where any one of the second image data selecting parts 232 is selected in the image data selecting screen 230C, the controller 80 returns the screen to be displayed on the operation panel 6 to the recording setting screen 220, and the controller 80 causes the image data in the recording setting screen 220 to indicate the selected image data, and causes the memory 84 to store information indicating that an image corresponding to the selected image data is to be recorded.

Further, in a case where any one of the second image data selecting parts 232 is selected in the image data selecting part screen 230B, the controller 80 causes the operation panel 6 to display the unregistered account screen 130 in FIG. 7A. Note, however, that in a case where the cancellation selecting part 133 is selected in the unregistered account screen 130 displayed in this situation, the controller 80 returns the display of the operation panel 6 to the image data selecting screen 230B. Further, in a case where the account registration is performed in a similar manner to that described above and where the recording apparatus 1 receives the response signal from the server 100, the controller 80 causes the operation panel 6 to display the image data selecting screen 230C. With this, the second image data selecting part 232 is switched from a state that the selection for executing the additional function cannot be executed to a state that the selection for executing the additional function can be executed.

Next, an operation in a case where the recording start selecting part 222 is selected in the recording setting screen 220 will be described.

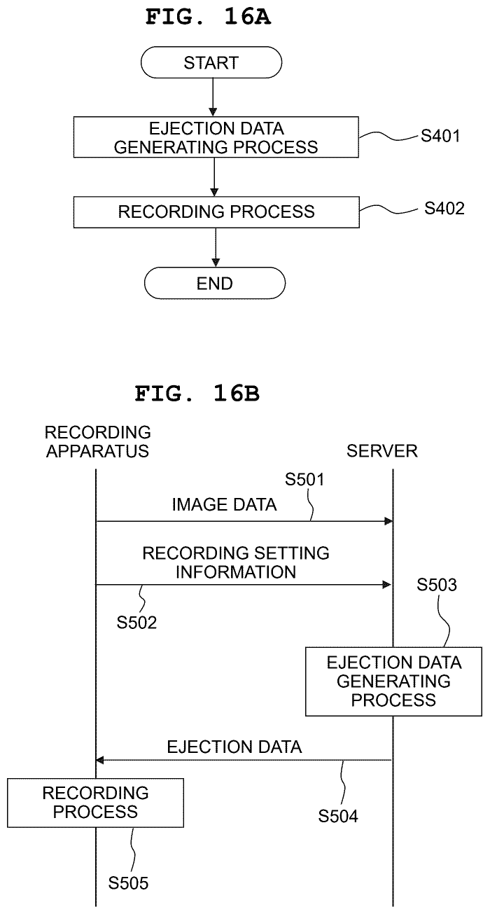

In a case where the recording start selecting part 222 is selected in a state that information indicating that the image of the first data format is to be recorded is stored in the memory 84, the controller 80 of the recording apparatus 1 executes the process according to the flowchart of FIG. 16A. To provide a detailed description, the controller 80 of the recording apparatus 1 first executes an ejection data generating process (step S401). In the ejection data generating process of step S401, the controller 80 of the recording apparatus 1 generates ejection data for causing the ink-jet head 12 to eject the ink(s) from the plurality of nozzles 10, from the image data of the selected first data format. Then, the controller 80 of the recording apparatus 1 executes the recording process (step S402). In the recording process of step S402, the controller 80 of the recording apparatus 1 controls the first carriage motor 86, the ink-jet head 12, the conveying motor 87, etc., so as to repeatedly perform the recording pass and the conveying operation; in the recording pass, the controller 80 causes the ink(s) to be ejected from the plurality of nozzles 10 to the sheet S, based on the ejection data generated in step S401. With this, the controller 80 cause the ink-jet head 12 to record an image corresponding to the selected image data on the sheet S.

In a case where the recording start selecting part 222 is selected in a state that information indicating that the image of the second data format is to be recorded is stored in the memory 84, the controller 80 of the recording apparatus 1 and the controller 101 of the server 100 perform the process according to a sequence diagram in FIG. 16B. To provide a detailed description, the controller 80 of the recording apparatus 1 transmits, to the server 100, the image data of the selected second data format and the recording setting information set in the recording setting screen 220 (step S501 and step S502).

The controller 101 of the server 100 executes an ejection data generating process of generating ejection data based on the image data and the recording setting information which have been received (step S503), and transmits the generated ejection data to the recording apparatus 1 (step S504). The controller 80 of the recording apparatus 1 executes the recording process in a case where the controller 80 receives the ejection data (step S505). In the recording process of step S505, the controller 80 of the recording apparatus 1 controls the first carriage motor 86, the ink-jet head 12, the conveying motor 87, etc., so as to repeatedly perform the recording pass and the conveying operation; in the recording pass, the controller 80 causes the ink(s) to be ejected from the plurality of nozzles 10 based on the received ejection data onto the sheet S. With this, the controller 80 causes the ink-jet head 12 to record an image corresponding to the selected image data on the sheet S.

Returning to FIGS. 6A to 6D, the update selecting part 125 is a part selected by the user so as to select whether or not to enable automatic update, which automatically updates the display of the screen displayed on the operation panel 6, after the recording apparatus 1 becomes able to communicate with the server 100. In a state that the automatic update is disabled, as depicted in FIGS. 6A to 6C, display of “automatic update OFF” in the update selecting part 125 indicates that the automatic update is disabled. In a case where the automatic update is enabled, as depicted in FIG. 6D, the display of “automatic update ON” in the update selecting part 125 indicates that the automatic update is enabled. Further, each time the update selecting part 125 is selected, the automatic update is alternately changed between the state that the automatic update is disabled and the state that the automatic update is enabled.

Note that in the present embodiment, the function which is executable by selecting each of the web selecting part 121, the application function selecting part 122, and the account information selecting part 124 in a state that the recording apparatus 1 and the server 100 are ready for communicating with each other and that the account registration has been made, and the function of recording an image corresponding to the second image data selecting part 232 on the sheet S each correspond to the “additional function”, of the present disclosure, which becomes executable by the recording apparatus 1 after the recording apparatus 1 and the server 100 are connected and after the account registration has been made. In the present embodiment, the function which is executable in the recording apparatus 1 before the recording apparatus 1 and the server 100 are connected, such as the function of recording, on the sheet S, an image corresponding to the first image data selecting part 231, corresponds to the “basic function” of the present disclosure.

Further, in the present embodiment, the external memory selecting part 123 in each of the main screens 120A to 120D corresponds to a “basic function selecting part” of the present disclosure. Furthermore, the web selecting part 121, the application function selecting part 122, and the account information selecting part 124 in each of the main screens 120A to 120D, and the second image data selecting part 232 in each of the image data selecting screens 230B and 230C correspond to an “additional function selecting part” of the present disclosure.

Moreover, in the relationship among the web selecting part 121, the application function selecting part 122 and the account information selecting part 124, one of any two selecting parts among the three selecting parts corresponds to a “first additional function selecting part” of the present disclosure, and the other of the any two selecting parts among the three selecting parts corresponds to a “second additional function selecting part” of the present disclosure.

Further, in the relationship among the external memory selecting part 123, the web selecting part 121, the application function selecting part 122 and the account information selecting part 124, and the first image data selecting part 231 and the second image data selecting part 232, the external memory selecting part 123 corresponds to the “basic function selecting part” of the present disclosure, the web selecting part 121, the application function selecting part 122, and the account information selecting part 124 each correspond to the “first additional function selecting part” of the present disclosure, the first image data selecting part 231 corresponds to the “basic setting selecting part” of the present disclosure, and the second image data selecting part 232 corresponds to the “second additional function selecting part” of the present disclosure. Furthermore, the main screens 120A to 120D each having the external memory selecting part 123, the web selecting part 121, the application function selecting part 122, and the account information selecting part 124 each correspond to a “first screen” of the present disclosure. Moreover, the image data selecting screens 230B and 230C each having the first image data selecting part 231 and the second image data selecting part 232 each correspond to a “second screen” of the present disclosure.

Moreover, in the present embodiment, the server-unconnected icon 127 corresponds to a “first icon” of the present disclosure, and the key icon 128 and the cloud icon 129 each correspond to a “second icon” of the present disclosure.

### Technical Effects

In the present embodiment, in the state the recording apparatus 1 is ready for communicating with the server 100 and the account registration has not been made, the controller 80 causes the operation panel 6 to display the additional function selecting part in a state that the selection for executing the additional function cannot be performed. Further, in the state that the recording apparatus 1 is ready for communicating with the server 100 and the account registration has been made, the controller 80 causes the operation panel 6 to display the additional function selecting part in a state that the selection for executing the additional function can be performed. With this, the user can easily understand how the additional function is added, such as the position of display and the displayed screen of the selecting part for performing the selection regarding the additional function, the operability and the ease of use of the additional function, before performing the account registration. Further, the user can add the additional function after being convinced of the ease of use of the additional function. Furthermore, such a situation is less likely to occur that although the user has added the additional function, the user is not satisfied with the ease of use of the additional function, and thus the user does not use the additional function after all.

Moreover, the user can easily understand what kind of additional functions will be added before registering his or her account. Namely, since the additional function selecting part is displayed in the recording apparatus 1 in the non-selectable state, the user has more opportunities to learn about the content of the additional function and to decide whether the additional function is necessary for the user himself or herself. Owing this, such a probability that the user might miss an opportunity to use the additional function since the user is not aware of the presence of the additional function is reduced, thereby improving the productivity of the user.

Further, in the present embodiment, in a case where the operation for the account registration is performed in a state that the recording apparatus 1 is ready for communicating with the server 100 and where the approval signal is transmitted from the recording apparatus 1 to the server 100, and in a case where the recording apparatus 1 receives the response signal from the server 100 in response to the approval signal, the additional function selecting part displayed on the operation panel 6 switches from the state that the selection for executing the additional function cannot be performed to the state that the selection for executing the additional function can be performed. With this, the user can select and execute the additional function by selecting the additional function selecting part immediately after the account registration. Furthermore, the occurrence of such a situation can be prevented that the additional function selecting part becomes to be in the state that the selection for executing the additional function can be performed in the state that the account registration has not been made, that is, in the state that the user has not given the approval. Some users consider, from the viewpoint of security, that the additional function with which the communication with the server 100 is generated is preferably not to be in the state that the selection for executing the additional function can be performed. Therefore, the additional function selecting part is preferably to be in the state that the selection for executing the additional function can be performed, after the user has given the approval, such as the account registration, etc., in the manner as described above.

Moreover, in the present embodiment, in a case where the additional function selecting part displayed on the operation panel 6 is selected in the state that the selection for executing the additional function cannot be performed, the unregistered account screen 130 for prompting the user to perform the account registration is displayed on the operation panel 6. With this, the user can easily understand that the additional function can be executed by the account registration. Further, in a case where the additional function selecting part displayed on the operation panel 6 is selected in the state that account registration has not been made, the user might not understand how to select the additional function selecting part only by causing the additional function selecting part to be non-selectable, in some cases. Furthermore, in this situation, the user might perform an unnecessary operation such as switching the screens so as to find a way to make the additional function selecting part selectable. In the present embodiment, as described above, since the controller 8 causes the operation panel 6 to display the unregistered account screen 130 in the case where the additional function selecting part is selected, the user can thereby understand how to make the additional function selecting part selectable. With this, the user can perform the account registration so that the additional function can be executed, without performing any unnecessary operation as described above.

Moreover, in the present embodiment, also in a case where any one of the web selecting part 121, the application function selecting part 122, the account information selecting part 124, and the second image data selecting part 232 is selected in the state that the account registration has not been made, the unregistered account screen 130 is displayed on the operation panel 6. With this, the user can easily understand how to make the additional function selecting part selectable in a case where the user operates the operation panel 6, with the intension to use any of the additional functions. Thus, the user can perform the account registration for making the additional function executable, without performing any unnecessary operation.

Further, in the present embodiment, in the state that the recording apparatus 1 is connected to the server 100 and the account registration has not been made, the main screen 120C has the external memory selecting part 123 as the basic function selecting part, and the web selecting part 121, the application function selecting part 122, and the account information selecting part 124 each as the additional function selecting part. Furthermore, in a case where the external memory selecting part 123 is selected, and further the image data selecting part 221a is selected in the recording setting screen 220, the controller 80 causes the operation panel 6 to display the image data selecting screen 230B including the first image data selecting part 231 as the basic function selecting part and the second image data selecting part 232 as the additional function selecting part.

Furthermore, also in either the case where any one of the web selecting part 121, the application function selecting part 122, and the account information selecting part 124 is selected in the main screen 120C or the case where the second image data selecting part 232 is selected in the image data selecting screen 230B, the controller 80 causes the operation panel 6 to display the unregistered account screen 130. With this, the user can understand how to make the additional function selecting part selectable also in the case where the user operates the operation panel 6 with the intention of executing an additional function, among the additional functions, corresponding to any one of the web selecting part 121, the application function selecting part 122, and the account information selecting part 124, and also in a case where the user operates the operation panel 6 with the intention of recording an image corresponding to the second image data selecting part 232. With this, the user can perform the account registration so as to make the additional function executable, without performing any unnecessary operation.

Moreover, in the present embodiment, the display of the additional function selecting part(s) displayed on the operation panel 6 is updated in a state that the automatic update function is enabled, and after the recording apparatus 1 becomes to be able to communicate with the server 100. With this, for example, in a case where an additional function is changed in the server 100, the change in the additional function can be reflected in the display of the additional function selecting part.

Further, in the present embodiment, by selecting the update selecting part 125, the state of the automatic updating function is switched between being enabled and being disabled. With this, the user can select whether to update the display of the additional function selecting part displayed on the operation panel 6 or not, after the recording apparatus 1 is ready for communicating with the server 100. In a case where the automatic updating function is enabled and where the additional function is changed, the change in the additional function can be immediately reflected in the display of the additional function selecting part. In a case where the automatic update is disabled, communication traffic between the recording apparatus 1 and the server 100 can be reduced.

Furthermore, in the present embodiment, the user can understand whether the recording apparatus 1 is ready for communicating with the server 100 or not, based on the presence or absence of the server-unconnected icon 127. Moreover, the user can also understand whether the account registration has been made or not, based on the key icon 128 and the cloud icon 129.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the foregoing, the embodiment of the present disclosure has been described. The present disclosure, however, is not limited to the above-described embodiment; various changes can be made to the present disclosure within the range described in the claims.

In the above-described embodiment, in a case where the account registration has not been made even though the recording apparatus 1 is ready for communicating with server 100, all the functions, which would be otherwise executable in the recording apparatus 1 in the case where the communication between the recording apparatus 1 and the server 100 is made possible, cannot be executed. The present disclosure, however, is not limited to this.

In first to fourth modifications, a part of the functions which can be made executable in the recording apparatus 1 by making the communication between the recording apparatus 1 and the server 100 possible, as described in the above-described embodiment, can be executed regardless of whether the account registration has been made or not. Further, the main screen displayed on the operation panel 6 in the state that the recording apparatus 1 is ready for communicating with the server 100 is the main screen 120D depicted in FIG. 6D, regardless of whether the account registration has been made or not.

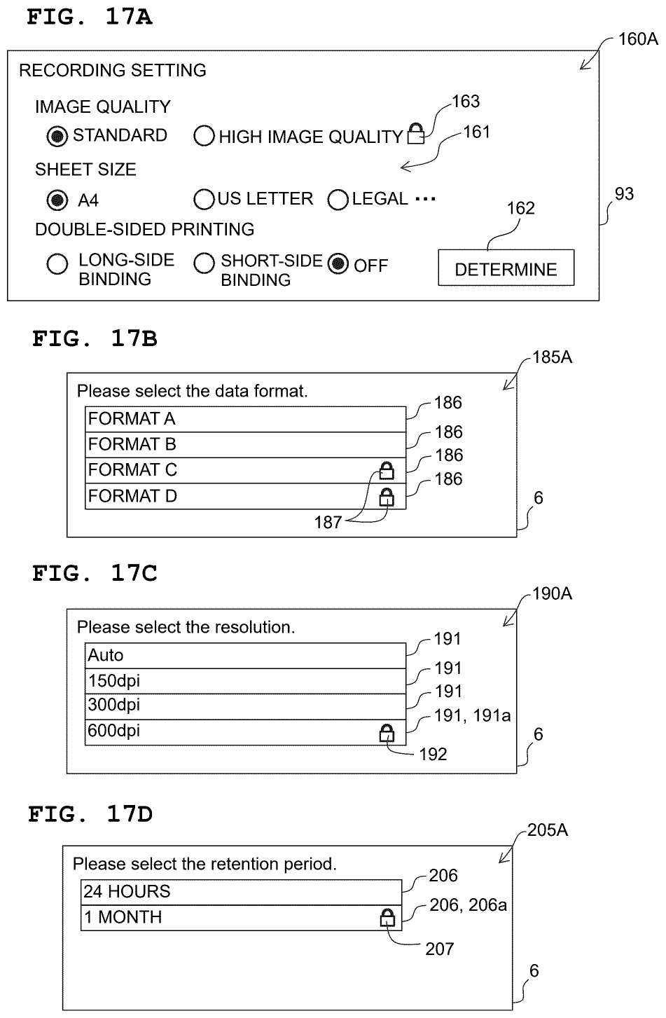

In the first modification, in the recording setting screen 160 displayed in a case where account registration has been made, the both of the standard image quality and the high image quality can be selected in the setting selecting part 161, as depicted in FIG. 9B, similarly to the above-described embodiment. In contrast, in a recording setting screen 160A displayed in a case where the account registration has not been made, as depicted in FIG. 17A, although the standard image quality can be selected in the setting selecting part 161, the high image quality cannot be selected in the setting selecting part 161. Further, in the recording setting screen 160A, a key icon 163 indicates that the high image quality cannot be selected. Note that in the first modification, the recording function in the high image quality among the functions of the first application corresponds to the “additional function” of the present disclosure.

In the second modification, in the data format selecting screen 185 displayed in the case where the account registration has been made, any of the data format selecting parts 186 can be selected as depicted in FIG. 11B, similarly to the above-described embodiment. In contrast, a data format selecting screen 185A displayed in the case where account registration has not been made, a data format selecting part 186a as a part of a plurality of data format selecting parts 186 cannot be selected as depicted in FIG. 17B. FIG. 17B depicts a case wherein the data format selecting parts 186a of the format C and the format D cannot be selected. Further, in the data format selecting screen 185A, the data format selecting parts 186a which cannot be selected each includes a key icon 187, and the key icon 187 indicates that the data format selecting parts 186a cannot be selected. Each of the data format selecting parts 186a which cannot be selected is, for example, a data format by which a higher load is placed on the controller 101 of the server 100, in a case where image data is generated, than by a data format corresponding to the data format selecting part 186 which can be selected regardless of whether the account registration has been made or not. As an example, a data format by which a high load is placed on the controller 101 of the server 100 in the case where the image data is generated is a data format in which the text in the image is searchable by an OCR process performed during the generation of the image data. Note that the term “OCR” is an abbreviation for Optical Character Recognition. Further note that in the second modification, the function, which is included in the functions of the second application, of attaching the image data of the format C and the image data of the format D and of transmitting the image data of the format C and the image data of the format D to the destination corresponds to the “additional function” of the present disclosure.

Note that in the second modification, although a part of the data formats is made non-selectable in the data format selecting screen 185, a part of the data formats may be made non-selectable in the data format selecting screen 200 depicted in FIG. 13A, similarly to the second modification. In this case, among the functions of the third application, a function of storing the image data of the format C and the image data of the format D corresponds to the “additional function” of the present disclosure.

In the third modification, in the resolution selecting screen 190 displayed in a case where the account registration has been made, any one of the resolution selecting parts 191 can be selected, as depicted in FIG. 11C, similarly to the above-described embodiment. In contrast, in a resolution selecting screen 190A displayed in a case where the account registration has not been made, a resolution selecting part 191a, as a part of a plurality of resolution selecting parts 191 is made non-selectable, as depicted in FIG. 17C. Further, the resolution selecting part 191a which cannot be selected includes a key icon 192, and the key icon 192 indicates that the resolution selecting part 191a is non-selectable. The resolution selecting part 191a which cannot be selected is, for example, a resolution selecting part 191 configured to select a higher resolution than the resolution selected by a resolution selecting part 191, which is included in the plurality of resolution selecting parts 191, which is different from the resolution selecting part 191a and which is selectable, regardless of whether the account registration has been made or not. As an example, the resolution selecting part 191a which cannot be selected is a resolution selecting part 191 which corresponds to the highest resolution among the plurality of resolution selecting parts 191, as depicted in FIG. 17C. Note that in the third modification, among the functions of the third application, a function of recording an image at a resolution corresponding to the resolution selecting part 191a corresponds to the “additional function” of the present disclosure.

In the fourth modification, in the retention period selecting screen 205 displayed in a case where the account registration has been made, any one of the data retention period selecting parts 206 can be selected as depicted in FIG. 13B, similarly to the above-described embodiment. In contrast, in a retention period selecting screen 205A displayed in a case where the account registration has not been made, a retention period selecting part 206a as a part of a plurality of retention period selecting parts 206 is made non-selectable as depicted in FIG. 17D. Further, in the retention period selecting screen 205A, the retention period selecting part 206a which cannot be selected includes a key icon 207, and the key icon 207 indicates that the retention period selecting part 206a cannot be selected. The retention period selecting part 206a which cannot be selected is, for example, a retention period selecting part 206 which is configured to select a retention period longer than another retention period selecting part 206 of the plurality of retention period selecting parts 206. In the fourth modification, among the functions of the third application, a function of storing the image data in the server 100 during a retention period corresponding to the retention period selecting part 206a corresponds to the “additional function” of the present disclosure.

Further, in the above-described embodiment, in a case where any one of the web selecting part 121, the application function selecting part 122, and the account information selecting part 124 is selected in the main screen 120C displayed in the case where the account registration has not been made, and in a case where the second image data selecting part 232 is selected in the image data selecting screen 230B, the controller 80 causes the operation panel 6 to display the unregistered account screen 130 for prompting the user to perform the account registration. That is, in a case where any additional function selecting part is selected among the plurality of additional function selecting parts, the controller 80 causes the operation panel 6 to display the unregistered account screen 130. However, the present disclosure is not limited to this.

For example, in a case where a certain additional function selecting part as a part of the plurality of additional function selecting parts is selected, the controller 80 may cause the operation panel 6 to display the unregistered account screen 130, whereas in a case where another additional function selecting part, of the plurality of additional function selecting parts, different from the certain additional function selecting part is selected, the controller 80 may maintain the display of the operation panel 6 unchanged. In this case, for example, in a case where any one of the web selecting part 121, the application function selecting part 122, and the account information selecting part 124 is selected in the main screen 120C, the controller 80 may cause the operation panel 6 to display the unregistered account screen 130, and in a case where the second image data selecting part 232 is selected in the image data selecting screen 230B, the controller 80 may maintain the display of the operation panel 6 unchanged. Alternatively, in a case where any one of the additional function selecting parts is selected, the controller 80 may maintain the display of the operation panel 6 unchanged.

Further, in the above-described embodiment, in a case where the recording apparatus 1 transmits the approval signal to the server 100, where the server 100 performs the process of the account registration based on the approval signal, and then where the controller 80 receives, from the server 100, the response signal corresponding to the approval signal, the additional function selecting part is switched from the state that the selection for executing the additional function cannot be performed to the state that the selection for executing the additional function can be performed, such that the main screen displayed on the operation panel 6 is switched from the main screen 120C to the main screen 120D, etc. The present disclosure, however, is not limited to this. For example, in a case where the additional function selecting part is selected before the recording apparatus 1 is ready for communicating with the server 100, a selecting part for selecting whether or not the execution of an additional function different from the account registration is enabled may be displayed. In a case where the execution of the additional function is selected in this selecting part, the execution of the additional function may be considered as being approved by the user in the recording apparatus 1, and the recording apparatus 1 may be made capable of executing the additional function, in response to the recording apparatus 1 being ready for communicating with the server 100. In other words, the execution of the additional function may be approved before the recording apparatus 1 is ready for communicating with the server 100. Further, the approval signal is not necessarily to be transmitted to the server 100 and the response signal corresponding to the approval signal is not necessarily to be received from the server 100.

Furthermore, in the above-described embodiment, the main screen 120C displayed in the state that the recording apparatus 1 is ready for communicating with the server 100 and where the account registration has not been made has the web selecting part 121, the application function selecting part 122, and the account information selecting part 124 each of which includes the key icon 128. On the other hand, the main screen 120D displayed in the state that the recording apparatus 1 is ready for communicating with the server 100 and the account registration has been made has the web selecting part 121, the application function selecting part 122, and the account information selecting part 124 each of which includes the cloud icon 129. In other words, in in the state that the recording apparatus 1 is ready for communicating with the server 100, the key icon 128 and the cloud icon 129 indicate whether or not the account registration has been made. However, the present disclosure is not limited to this.

For example, in the main screen 120C, the web selecting part 121, the application function selecting part 122, and the account information selecting part 124 may include an icon different from the key icon 128. Further, in the main screen 120D, the web selecting part 121, the application function selecting part 122, and the account information selecting part 124 may include an icon different from the cloud icon 129. Alternatively, for example, in the main screen 120C, each of the web selecting part 121, the application function selecting part 122 and the account information selecting part 124 may include the key icon 128, and in the main screen 120D, each of the web selecting part 121, the application function selecting part 122 and the account information selecting part 124 may not include either the key icon 128 or the cloud icon 129. Still alternatively, whether or not the account registration has been made may be indicated by a difference in the aspect of display other than the icon.

Furthermore, in the above-described embodiment, the main screen 120A displayed in the state that the recording apparatus 1 is not connected to the network 99 has the web selecting part 121, the application function selecting part 122, and the account information selecting part 124 each of which includes the network-unconnected icon 126. Moreover, in the above-described embodiment, the main screen 120B displayed in the state that the recording apparatus 1 is connected to the network 99 but is not ready for communicating with the server 100 has the web selecting part 121, the application function selecting part 122, and the account information selecting part 124 each of which includes the server-unconnected icon 127. That is, in the above-described embodiment, the network-unconnected icon 126 indicates whether the recording apparatus 1 is connected to the network 99 or not, and the server-unconnected icon 127 indicates whether the recording apparatus 1 is ready for communicating with the server 100 or not. However, the present disclosure is not limited to this.

For example, whether or not the recording apparatus 1 is connected to the network 99 may be indicated by an icon other than the network-unconnected icon 126, or by an aspect of display other than the icon, such as by a displaying the respective selecting parts in a graying out manner. Further, whether or not the recording apparatus 1 is ready for communicating with the server 100 may be indicated by an icon other than the server-unconnected icon 127, or by an aspect of display other than an icon, such as by displaying the respective selecting parts in a graying out manner.

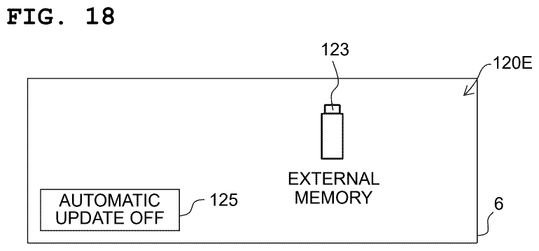

Furthermore, the present disclosure is not limited to displaying the main screen including the web selecting part 121, the application function selecting part 122, and the account information selecting part 124 in the state that the recording apparatus 1 is not ready for communicating with the server 100. In a fifth modification, in a state that the recording apparatus 1 is not connected to the network 99, and in a state that although the recording apparatus 1 is connected to the network 99, the recording apparatus 1 is not ready for communicating with the server 100, the controller 80 causes the operation panel 6 to display a main screen 120E depicted in FIG. 18. The main screen 120E is obtained by removing the web selecting part 121, the application function selecting part 122, and the account information selecting part 124 from each of the main screens 120A and 120B. Further, in the fifth modification, in a case where the image data selecting part 221a is selected in the recording setting screen 220 in FIG. 15A either in the state that the recording apparatus 1 is not connected to the network 99 or in the state that although the recording apparatus 1 is connected to the network 99, the recording apparatus 1 is not ready for communicating with the server 100, the controller 80 causes the operation panel 6 to display the image data selecting screen 230A depicted in FIG. 15B. That is, in the fifth modification, in the state that the recording apparatus 1 is not ready for communicating with the server 100, the controller 80 does not cause the operation panel 6 to display the additional function selecting part.

In the fifth modification, in the state that the recording apparatus 1 and the server 100 are not ready for communicating with each other, the additional function selecting part is not displayed on the operation panel 6; after the recording apparatus 1 and the server 100 become ready for communicating with each other, the additional function selecting part is displayed on the operation panel 6. With this, the user can easily understand that in the case where the recording apparatus 1 and the server 100 are not ready for communicating with each other, the additional function cannot be executed by performing the account registration. Further, the user can easily understand that in the state that the recording apparatus 1 and the server 100 are ready for communicating with each other, the additional function can be executed by performing the account registration.

Furthermore, in the above-described embodiment, although whether or not to automatically update the screen displayed on the operation panel 6 after the recording apparatus 1 is connected to the server 100 is configured to be switchable by selecting the update selecting part 125, the present disclosure is not limited to this. For example, after the recording apparatus 1 is connected to the server 100, the screen displayed on the operation panel 6 may be updated all the time. Alternatively, for example, after the recording apparatus 1 is connected to the server 100, the screen displayed on the operation panel 6 may be configured not to be automatically updated, and the screen displayed on the operation panel 6 may be configured to be updated only in a case where the user performs a predetermined operation on the operation panel 6.

Moreover, in the above-described embodiment, in a case where the screen displayed on the operation panel 6 is automatically updated after the recording apparatus 1 is connected to the server 100, although the screen displayed on the operation panel 6 is automatically updated regardless of whether the account is registered or not, the present disclosure is not limited to the above. The automatic update may be performed only in a case where the account is registered, or may be performed only in a case where the account is not registered. In a case where the automatic update is performed only in a case where the account is registered, such a situation is prevented that any unnecessary communication occurs between the recording apparatus 1 and the server 100, for example, in a case where the user does not intend to use the additional function and has not registered the account.

Further, in the above-described embodiment, although the operation panel 6 of the recording apparatus 1 is caused to display the selecting part regarding the recording apparatus 1, and the user is caused to operate the operation panel 6 so as to select the selecting part, the present disclosure is not limited to this. For example, the display 93 of the external terminal 92 may be caused to display the selecting part for the recording apparatus 1, and the user may be caused to operate the operating part 94 of the external terminal 92 so as to select the selecting part.

Furthermore, in the above-described examples, although the approval to execute the additional function is given by performing the account registration, the approval to add the additional function is not limited to being via the account registration. For example, the approval to execute the additional function may be given in a case where a specific operation other than the operation for the account registration is performed by the user on the operation panel 6 in the state that the recording apparatus 1 is connected to the server 100. A selecting part for selecting whether or not to allow the additional function to be executed may be displayed regardless of the account registration or the connection with the server 100. The recording apparatus 1 may determine that, in response to the selection of the above-described selecting part, the execution of the additional function is approved by the user.

Moreover, in the foregoing, although the example wherein the present disclosure is applied to a recording apparatus including a recording part having a so-called serial head which ejects the ink(s) from the plurality of nozzles while moving in the scanning direction together with the carriage has been described, the present disclosure is not limited to this. For example, the present disclosure is also applicable to a recording apparatus including a recording part having a so-called line head which extends over the entire length of the sheet in the scanning direction.

Further, in the foregoing, the recording part 2 of the recording apparatus 1 is the ink-jet printer which ejects the ink(s) from the nozzles so as to perform recording on the sheet S. The present disclosure, however, is not limited to this. For example, the recording part of the recording apparatus may be different from the ink-jet printer, such as a laser printer, a thermal printer, etc.

What is claimed is:

1. A recording apparatus comprising:
a recording part;
a display;
an operating part configured to allow a user to operate; and
a controller, wherein
the controller is configured to perform control regarding an additional function which is executed by the recording apparatus after the recording apparatus and an external apparatus are connected and after approval is given by the user, and control regarding a basic function which is executed by the recording apparatus before the recording apparatus and the external apparatus are connected, and
the controller is configured to execute:
causing the display to display a basic function selecting part which is selected by an operation of the operating part and via which the basic function is selected and an additional function selecting part which is selected by the operation of the operating part and via which the additional function is selected;
in a case where the user has not given the approval, causing the display to display the additional function selecting part in a state that selection for executing the additional function is not ready; and
in a case where the user has given the approval, causing the display to display the additional function selecting part in a state that the selection for executing the additional function is ready.

2. The recording apparatus according to claim 1, further comprising a communicating part configured to communicate with an external apparatus, wherein
the controller is configured to perform transmission of an approval signal to the external apparatus, in response to the approval given by the user, in a state that the recording apparatus is ready for communicating with the external apparatus, and
in a case where the controller receives, from the external apparatus, a response signal corresponding to the transmission of the approval signal, the controller is configured to switch the additional function selecting part, which the controller causes the display to display, from the state that the selection for executing the additional function is not ready to the state that the selection for executing the additional function is ready.

3. The recording apparatus according to claim 1, wherein
the approval is registration, by the user, of his or her own account.

4. The recording apparatus according to claim 1, wherein
in a case where the additional function selecting part is selected in a state that the user has not given the approval, the controller is configured to cause the display to display a screen prompting the user to give the approval.

5. The recording apparatus according to claim 4, wherein
the additional function selecting part includes a first additional function selecting part via which a first additional function is selected, and a second additional function selecting part via which a second additional function is selected and which is different from the first additional function, and
in a case where either the first additional function selecting part or the second additional function selecting part is selected in the state that the user has not given the approval, the controller is configured to cause the display to display the screen for prompting the user to give the approval.

6. The recording apparatus according to claim 5, wherein
the controller is configured to:
cause the display to display a first screen including the basic function selecting part and the first additional function selecting part; and
cause the display to display, in response to selection of the basic function selecting part, a second screen including a basic setting selecting part via which a setting of the basic function is made, the basic function being selected by the operation of the operating part, and the second additional function selecting part.

7. The recording apparatus according to claim 2, wherein
in a state that the recording apparatus is not ready for communicating with the external apparatus, the controller is configured not to cause the display to display the additional function selecting part, and
after the recording apparatus becomes ready for communicating with the external apparatus, the controller is configured to cause the display to display the additional function selecting part.

8. The recording apparatus according to claim 2, wherein
after the recording apparatus becomes ready for communicating with the external apparatus in at least one of the state that the user has given the approval and the state that the user has not given the approval, the controller is configured to execute an updating process of communicating with the external apparatus to update display of the additional function selecting part displayed in the display.

9. The recording apparatus according to claim 8, wherein
the controller is configured to cause the display to display an update selecting part which is selected by the operation of the operating part and which is configured to select whether to execute the updating process after the recording apparatus becomes ready for communicating with the external apparatus.

10. The recording apparatus according to claim 2, wherein
the additional function selecting part includes a first icon configured to indicate whether the recording apparatus is in the state that the recording apparatus is ready for communicating with the external apparatus, and a second icon configured to indicate whether the user has given the approval.

11. A recording system comprising:
a recording apparatus including a recording part;
an external apparatus including a controller and being configured to communicate with the recording apparatus;
a display configured to communicate with at least one of the recording apparatus and the external apparatus; and
an operating part configured to allow a user to operate, wherein
the recording apparatus is configured so that an additional function is added to the recording apparatus by an approval given by a user, the additional function being different from a basic function which is executed before the recording apparatus and the external apparatus are connected, and
the controller is configured to execute, by controlling the recording apparatus or the display:
causing the display to display a basic function selecting part which is selected by an operation of the operating part and via which the basic function is selected and an additional function selecting part which is selected by the operation of the operating part and via which the additional function is selected;
in a state that the user has not given the approval, causing the display to display the additional function selecting part in a state that selection for executing the additional function is not ready; and
in a state that the user has given the approval, causing the display to display the additional function selecting part in a state that the selection for executing the additional function is ready.
